(19) United States
(12) Patent Application Publication
(10) Pub. No.: US 2003/0083994 A1
(43) Pub. Date: May 1, 2003

(54) Process to build and use usage based licensing server data structure for usage based licensing

(76) Inventors: Arun Ramachandran, Cupertino, CA (US); Nathan Watson, San Mateo, CA (US); Ashutosh Das, Campbell, CA (US); Dana Austin Chinn, Campbell, CA (US)

Correspondence Address: FALK AND FISH, 16590 OAK VIEW CIRCLE, MORGAN HILL, CA, 95037, US

(21) Appl. No.: 10/003,004

(22) Filed: Nov. 1, 2001

(51) Int. Cl. G06F 17/60

(52) U.S. Cl. 705/52

(57) ABSTRACT

A system for modeling a distribution system to sell resources or license resources such as software on a usage basis, and for storing usage data or sales data reported from licensees and distributors and prepare reports or invoices therefrom. The system uses a centralized server which maintains a data structure which has data entries to: model entities such as vendors, licensees and distributors in the distribution system; record license terms; memorialize the existence of licenses; and store usage data for each resource by each licensee. This usage data is reported by agent programs on the computers of licensees. The server is programmed to provide an interface so remote users can access their data and other data to which access privileges exist and to receive uploaded usage data from the agent programs on the licensee computers. The server is also programmed to convert usage data to metric data using programmable conversion formulas and to convert metrics to central service units at a higher level of abstraction also using programmable conversion formulas.

### BACKGROUND OF THE INVENTION

In the world of software and other product distribution and compensation based upon licensed usage such as software distribution, there is a need for an efficient way for vendors to license their programs or other resources to clients on a usage basis. The old paradigm of “licensing” programs to users by selling them the media on which the program while pretending to maintain title to the program itself is a fiction at best as there is no real control of how much usage of the program the licensee makes after the media is in his control.

On certain expensive programs that some customers cannot afford to buy, a better way of providing access to these programs is by a “pay as you go” licensed usage basis where the more usage of a resource is made, the more the license fees are. This paradigm has the attributes of a real license and increases vendor revenue by providing access to more users than would otherwise be the case.

The problem with this “pay as you go” paradigm, is that usage of a program or other resource at a customer site needs to be monitored and usage data sent back to a licensing server for billing purposes. This requires a server data structure which contains data that represents the complex distribution chain and which stores usage data by users in the distribution system. The distribution chain or “tree” consists of vendors who create or supply the resources to be licensed, the resources to be licensed, the customers and distributors which use or distribute the resources, which resources each distributor has access to, the clients of distributors, and the resources the clients of the distributors have access to. Multiple levels of distributors and clients need to be represented and usage data by all clients needs to be stored. An application programmatic interface (API) or communication protocol and interface to allow vendors to log in and declare resources and the clients and distributors of the vendor who can access the resources and to which resources each client or distributor has access privileges is needed. An API or protocol and interface is also needed to allow usage data to be uploaded into the data structure and to allow clients to data mine the data structure for data pertinent to the client but not get data to which the client should not have access. An API or protocol and interface is also needed to allow usage data that has been collected in the data structure to be mined by the vendors. Vendors need to learn more about how their resources are being used for purposes of modifying it to better suit the needs of users or to introduce more products.

A method is therefore needed to collect usage data at the client site, transmit it to a server that does usage-based licensing and maintains a data structure that models the distribution system. There the usage data must be stored in such a way that usage based licensing can be implemented and metrics generated from the usage data that allows usage based licensing billing or reports to be generated. It would also be helpful to be able to translate the metrics into different types of units that simplify the process of generating understandable or simpler bills or reports. It would also be helpful to be able to translate the usage data for each client into a financial statement of account in a manner which is independent for each client based upon the license terms each client has. This would be true for a distributor of a vendor also who, to the vendor, appears to be just another client.

As far as the applicants are aware, no such data structures or systems and protocols/interfaces or methods exist to implement “pay as you go” licensing or a product sales distribution system. Such a server system, data structure and protocols are needed.

### SUMMARY OF THE INVENTION

The teachings of the invention contemplate a process to collect usage data from remote machines which are using resources under usage-based licenses using agent programs installed on the machines where the usage is being made. That usage data is transmitted over a WAN such as the internet to a usage measuring server from time to time. The server receives the usage data and stores the usage data for use of each resource by a particular user in a separate usage buffer dedicated to storing only usage data of that particular resource by that particular user. After the usage data is stored, a distillation program is used to convert it to metric data.

The preferred embodiment of the process implements additional steps wherein authorized persons may log into the usage measuring server over the internet using their browser and exercise a web interface to access the metric data or usage data or other data. The other data which may be accessed, in some embodiments, includes, without limitation, data defining resources available for licensing or defining licensing terms thereof or entities who have taken licenses. The web interface allows the user to change the data defining resources available, terms of licenses, add or delete licenses, etc.

In the preferred embodiment, the usage measuring server implements steps to control access by using security barriers to prevent unauthorized persons from changing usage or metric data or viewing or altering data of other users which said user has no rights to view or alter. Users are authenticated when they log in using a user name and password, and, if authenticated, configuration data is consulted by the server which defines the access privileges of the user.

In some species, the usage measuring server also controls what types of usage data is collected by the agent programs by sending messages directly or indirectly to the agent programs that tell them what usage data to collect. Usually this is done by sending the message to a licensing server at the client facility which is coupled to all the agent programs via a local area network. This licensing server sends messages to the agent programs controlling what type of usage data they collect for every resource. The messages the usage-measuring server sends to the licensing servers also tell which resources are still available for use. Thus, for example, when a license to use a particular resource expires and the licensee does not renew it, a message is sent to the licensing server of that licensee that the license on that resource is expired. Then, when the agent program detects a launch of that program and requests authorization for the launch from the licensing server, a message will be sent back denying authorization for the launch. This causes the agent to invoke a function call of the operating system API to kill execution of the program whose license has expired.

In some species, the usage data is stored in logical compartments within the usage buffer which correspond to different time intervals in a sequence of time intervals such as storing usage on each day of the week in a different logical partition of the same usage buffer. This enables temporal processing of the usage data to add time of usage information which may be important in some usage-based licensing applications. In some species, the duration of the time interval spans of the logical partitions is programmable.

In some species, the usage data is collected in separate logical or physical time compartments of the same usage buffer, and metrics are generated separately for each time compartment using the same distillation program. This can be accomplished by following pointer data to the appropriate distillation program for the resource that corresponds to the usage data in the time compartment and then using that distillation program to process the usage data in the time compartment using any license term data that is necessary to properly calculate the metrics, and then repeating this process for every time compartment. The license term data that pertains to particular usage data can also be found by following pointer data in the data structure.

Multiple embodiments for doing multiple rollups of usage data during each time interval and for summarizing the metrics generated for each time interval during a larger interval either automatically upon some schedule or upon request only or upon a configurable schedule are also disclosed. In some species, the length of the larger interval is programmable or the method of rollup is configurable.

### BRIEF DESCRIPTION OF THE DRAWINGS

FIG. 1 is a diagram of a typical client-server system in which the invention is deployed.

FIG. 2 is a diagram of the data structure in the server that represents a three level distribution system with one organization supplying two resources and two clients and a distributor having usage privileges to the two resources as well as two clients of the distributor having usage privileges of one or both resources.

FIG. 3 is a diagram of typical raw usage data stored in the data structure showing how the distillation process summarizes the raw usage data into metrics.

FIGS. 4A and 4B are a more detailed view of the data structure 22 of the server 20 in FIG. 1 and the communication paths to agent programs that monitor usage at client facilities.

FIG. 5 is another example of a data structure that could be maintained by the server 22 for just the data pertaining to an entity Org: Dist 1 who is both a vendor of another organization's resources R1, R2 and R3 and a distributor of its own resource R4. FIG. 5 also illustrates how a CSU distillation program can convert metrics to CSU units such as dollars. FIG. 5 also illustrates how a customer such as Org: Dist 1 can create his own distillation procedure to augment, supplement or replace the distillation procedure defined by the creator of the resource.

FIG. 6A is a flowchart of the process to programmably map usage data to metric data.

FIG. 6B is a flowchart of the process to programmably map usage data to metric data using whatever distillation program is pointed to by programmable configuration data such that certain distillation programs can be used for some clients and other distillation programs, perhaps authored by the clients themselves or otherwise custom tailored for one or more clients can be used for those clients.

FIG. 7 is a flowchart of the process to programmably map metric data to central service units.

FIG. 8 is a flowchart of the overall process of collecting usage data at the client sites, uploading it to a central server and storing it there and processing said usage data into metric data and allowing access to the raw usage data and metric data.

FIGS. 9A and 9B are a flowchart of the general process to build the data structure of the usage measuring server and provided restricted access to data stored therein.

FIG. 10 illustrates a data structure in which each customer could have a custom mapping from metrics to CSUs by virtue of having the pointer to the mapping program stored in that customer's raw usage data buffer(s) which are not shared by other customers.

FIG. 11 is a flowchart of a process to implement metric to CSU conversion using a single CSU distillation program linked to each provisioning item or at least to the provisioning items under which customers who want CSU based reports have taken licenses . . .

FIG. 12 is a flowchart of a process to implement metric to CSU conversion using custom constants for at least some customers who want CSU based reports and to use a different CSU distillation program for every customer.

FIG. 13 is a flowchart of the process to create a data structure to support suite licensing and to use the data structure to implement suite licensing of multiple resources available from different vendors.

FIG. 14 is a flowchart of the process that is implemented with a user wants to shop all available license deals on a particular resource regardless of which vendor or distributor makes the resource available.

FIG. 15 is a diagram illustrating how usage data may be stored in the order in which it arrived as well as by the day of the week it occurred.

FIG. 16 is a flowchart of the process to implement this time segmentation of usage data and generate metrics for each segment.

FIG. 17 represents the hypothetical numerical values of metrics M1, M2 and M3 for Monday, Tuesday and Wednesday after rollup A on Tuesday using the usage data of FIG. 15.

FIG. 18 represents the numerical values of metrics M1, M2 and M3 after rollup B on Wednesday using the raw usage data of FIG. 15 for one alternative embodiment which limits the input to each rollup to only usage data for uses after the last rollup.

FIG. 19 represents the preferred embodiment wherein each successive rollup during any particular time segment restates the metrics for that time period taking into account all the usage data for uses during that time segment before the time of the rollup regardless of when the usage occurred relative to the time of the last rollup.

FIG. 20 represents an embodiment wherein each successive rollup will restate the metrics for a time segment using all the usage data for that time segment that occurred before the time of rollup, but if no new usage data has been stored for a particular time segment for usage since the time of the last rollup, no restatement of the metrics for that day will occur.

FIG. 21 is a diagram of a data structure in usage measuring server 20 which allows multilevel temporal summarization of usage data for both customers of a distributor as well as the distributor itself.

FIG. 22 is a flowchart of a process illustrating how the data structure is presented to the user one level of the tree at a time as links that the user can follow manually to only the data he wants.

FIG. 23 is a diagram of an example data structure which illustrates some of the concepts of security barriers to prevent users from obtaining access to information in the data structure which does not belong to them. .

FIGS. 24A and 24B are a flowchart of the process to limit access of a user to only that data in the data structure to which the user's data entry is directly or indirectly linked, and to only allow modification of accessed data by users authorized to modify that type of data.

FIG. 25 is an exemplar data structure for distribution of resource items R1 through R12 for sale by two vendors through a nationwide network of regional distributors each of which sells the resources directly and through retail stores in their area.

FIG. 26 represents a diagram of a search template, organization 780 with an interest in obtaining some resource may compose to search the data structure of FIG. 25.

FIG. 27 shows a typical taxonomy of a data structure.

FIG. 28 is a flowchart of typical processing to allow searching of the data structure based upon user defined criteria.

### DETAILED DESCRIPTION OF THE PREFERRED AND ALTERNATIVE EMBODIMENTS

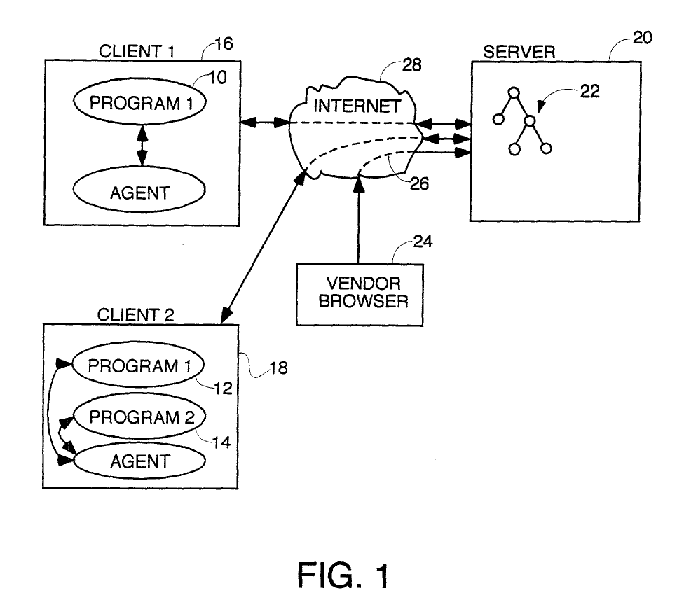

Referring to FIG. 1, there is shown a block diagram of a system of which the invention is a part. The system can be used to gather data about resource usage of resources, typically computer programs 10, 12 and 14 on computers on local area networks at different client facilities 16 and 18. Agent programs at the client facilities gather usage information and report that usage data to a centralized location which gathers such data and charges for usage on an agreed upon usage-based licensing basis. The agent programs can be installed on the client computers 16 and 18, or they may be installed on other computers and communicate with the client computers 16 and 18 via any data path to gather usage data about the licensed resources. The centralized location is referred to in the claims as a usage measuring server 20 but will hereafter be referred to simply as the server. This server 20 is not to be confused with another license monitoring server, not shown, at each client, which is coupled to said client computers 16 and 18 by any data path, which receives, from said agent or monitoring programs, messages that certain resources have been launched and responds with launch authorization or denial messages after checking data indicating which resources are authorized for use and which are not. The details of the client side structure for agents monitoring resources and reporting to a client license authorization server and uploading data to server 20 are included within U.S. patent application Ser. No. 09/660,253, filed Sep. 12, 2000, entitled SYSTEM FOR MONITORING USAGE OF COPYRIGHT PROTECTED SOFTWARE WITH WAN USAGE DATA UPLOADS FOR BILLING AND OTHER PURPOSES, which is hereby incorporated by reference. Only the agent programs are included here to avoid cluttering the diagram since the claims generally cover processes and structures mostly implemented on the side of server 20. The license-monitoring server is programmed to receive and store usage data received from said agent programs, which said agent programs gather as licensed resources are used. The license monitoring server is also programmed to receive licensing data from said server 20, which are not, and resources are licensed for use and which are not, and what types of usage data the agent programs are to gather about each licensed resource. The license monitoring server is also programmed to send messages to said agent programs instructing them what types of usage data to collect from said resources as they are used. The license-monitoring server also programmed to upload the usage data collected from the agent programs to server 20. The license monitoring server also programmed to received launch authorization request messages from said agent programs and looking up the resource that was launched, and determining whether launch of the resource is authorized or not, and sending a launch authorization or denial message based upon the result of the lookup.

Server 20 maintains a data structure 22. The usage measuring server 20 is programmed to send messages to each license monitoring server, which at least indicates which resources are licensed for use and which type of usage data is to be collected regarding each licensed resource. Server 20 is also programmed to receive usage data regarding the use of each resource on each client computer and store that usage data in an appropriate usage data buffer in a data structure in said server. The data structure 22 has data therein which represents the manufacturers or vendors which supply certain resources, what resources those manufacturers or vendors declare, who the clients and distributors of the vendor or manufacturer are, which resources each client or distributor has access to, who the clients or sub-distributors of each distributor are, and usage data the reflects the usage each client or distributor makes of each resource. In the case of distributors and sub-distributors, the data structure 22 also includes data which indicates how much use the clients and sub-distributors (either themselves or through clients or sub sub-distributors) made of each resource. Any level of complexity of a distribution chain can be represented by data structure 22.

The server 20 periodically or from time to time downloads to a license server (not shown) at each client facility certain data derived from data structure 22. This data defines which usage criteria are to be monitored by agent programs executing on each computer on the local area network(s) of the client, how often this usage data is to be uploaded, which resources each client has authorized access to. The data may also include limitations if, for example, the client has a license which requires payment of $X per use up to Y maximum uses per month or other such limited license terms. When a client launches a program or otherwise uses a resource, the agent program will report this fact to the local license server (not shown) and the local license server will respond with a message as to whether the use is authorized or not. If not, the agent program invokes a function of the operating system to kill the execution of the unauthorized resource thereby blocking unlicensed access to it.

To create the data structure 22 in server 20, a vendor which created the licensed resources can, using a browser process 24, log into server 20 through internet data path 26 (or via any other data path such as direct dial up, dedicated WAN, private virtual network, etc.) through internet 28 to declare which resources exist in the data structure and that the vendor controls them.

A resource is something the use of which can be measured and whose access can be controlled, and, in the preferred embodiment, is a computer program subject to a license agreement. Resources are represented by items in a data structure in a server, each data structure representing a distribution system. Every time a resource runs, information about it can be gathered by agent processes on the computer on which the resource ran or elsewhere on the LAN. This information includes such items as how many files were opened or processed, how many pages and/or diagrams were created, how much CPU time was used.

Resources can be declared by a member of a software vendor organization by logging into the server and declaring which resources exist that the vendor controls.

The data structure 22 also includes objects and linkages which represent the relationships between resources such as services provided by an organization and organizations such as clients that consume those resources as well as data that represents the actual amounts of usage. In the case of resources in the form of computer programs, the data structure includes data that represents the organization that licenses a particular program or programs (the licensor), data that represents the programs that the company licenses, the customer organizations that license the programs (the licensee) and data that represents the access privileges of each such organization to one or more of these programs. All this data represents actual relationships and access privileges that exist at some customer location. The data structure will also include actual usage data for each program which was gathered at the customer facility by agent processes as the programs are used. This usage data is uploaded to the local server in the client organization LAN that authorized the launch. Thus, a customer may have a copy of a program on one or more computers, but his access privileges may have lapsed because of expiration of a license or for any other reason. Usage of the copy of the program will then be blocked by the server 20 or a local license server because the lack of authorization to use the program will be reflected in the data structure on server 20. This may happen immediately upon an attempted launch in systems where the agents detect launches and report this fact in real time to the server 20, or it may be at some time later as a result of periodic downloads of access privileges and other data such as what usage data is to be collected and which clients have authorization to use which resources. These downloads of access privilege data and other data relevant to usage-based licensing (hereafter licensing criteria) occur over the internet or other WAN from server 20 to a local license server (not shown) at each customer location.

For customers that do have access to a particular resource, that access privilege will be part of the licensing criteria downloaded from the server 20. As the resource is used at the customer premises, usage data is gathered and stored locally in a database or file kept at the customer location. That usage data is later uploaded to central server 20 for purposes of billing.

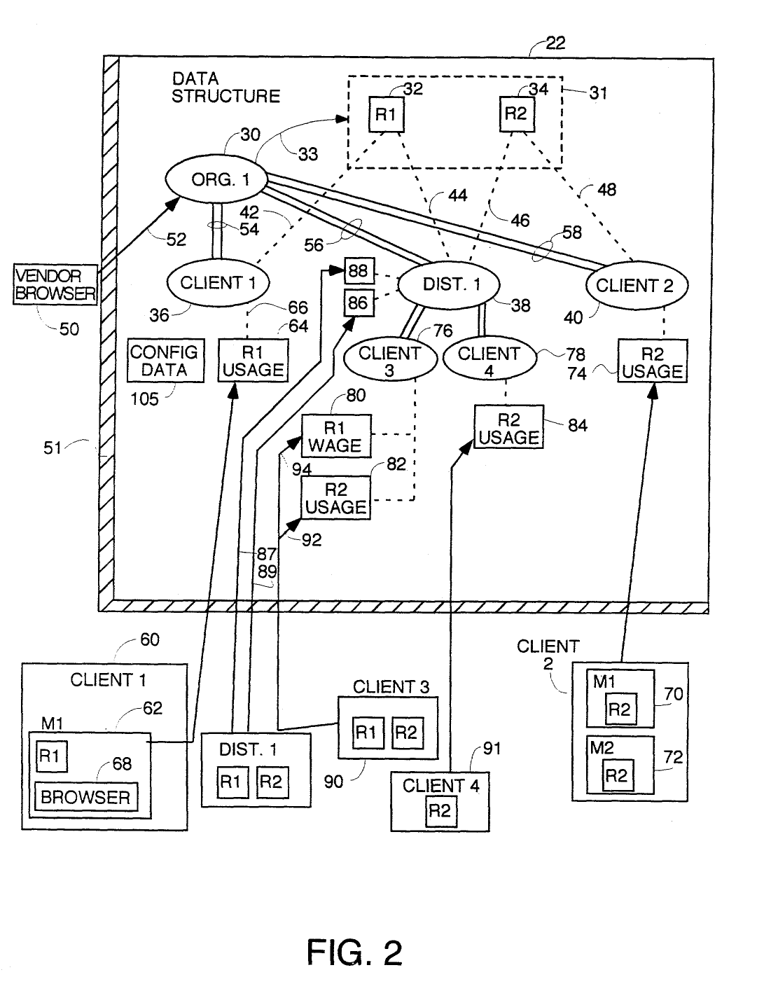

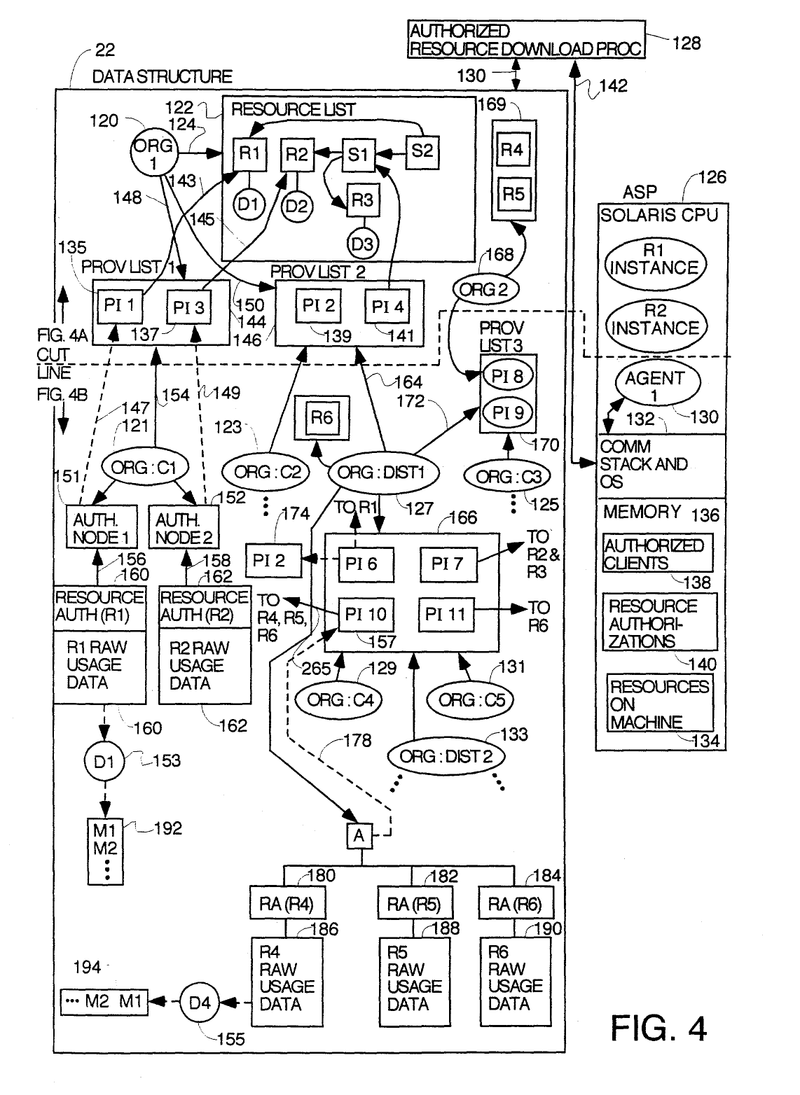

Referring to FIG. 2, there is shown a diagram of a typical data structure in server 20. A vendor organization represented by data object 30 has declared resources R1 and R2 represented by data objects 32 and 34 on a resource list 31 pointed to by the user organization data object via pointer data represented by arrow 33. As the term is used herein, a “data object” can be a conventional data object as the term is used in the object oriented programming sense (programs, an interface to invoke those programs, and an associated data structure), or it can be a simpler entity such as a table with rows and columns of data or a simple buffer space in memory which stores data memorializing the existence and attributes of some particular aspect of the usage-based licensing/distribution system the server data structure 20 models. Each vendor organization has at least one resource list. Each resource on every resource list has a pointer in the table representing the resource (each resource is typically, but not always, represented by a table) that points to the address of a distillation procedure that functions to distill raw usage data for that resource into metrics for that resource. Thus, resources R1 and R2 point to distillation procedure 38. A more detailed data structure shown in FIGS. 4A and 4B has resources R1, R2 and R3 on resource list 122 pointing to distillation procedures D1, D2 and D3, respectively. The distillation procedure for each resource must be able to understand and process the particular types of raw usage data that the monitors or agents on the client computers of the users are sending back about use of that resource.

In the particular example chosen to illustrate the data structure in FIG. 2, three sub-organizations 36, 38 and 40 have access privileges to resources R1 and R2, as represented by dotted lines 42, 44, 46 and 48. The vendor represented by data object 30 sets up data object 30 using a browser process 50 by logging into the server 20 and sending message(s) 52 which declare the existence of resources R1 and R2 and create sub-organizations 36 and 38 as organizations the vendor has some client or distributor relationship with, as represented by lines 54 and 56. Messages 52 also declare that organization 40, which already exists as an object in the data structure, is to be set up as an organization having a client relationship 58 with organization 30.

Sub-organizations 36, 38 and 40 all use and/or distribute resources 32 and 34. Client 1, represented by object 36, has a premises 60 in which machine 62 runs resource R1. Usage data is collected and uploaded by a browser or other process 68 to server data structure 22, and is represented therein by data object 64, which is linked by pointer 66 to client object 36. Client 1 can log in with browser process 68 and access the data structure and gather data about her own usage such as what is the amount of current usage of any particular resource? Client 2 may have two machines 70 and 72 each running R2. Usage data for use of R2 on both machines is gathered and stored in data object 74 linked to sub-organization data object 40.

Sub-organization distributor 38 can also log in from his browser and create client data objects 76 and 78 which represent organizations 90 and 91 that are his clients, and can define to which resources these clients have access of the resources to which the distributor 38 himself has access. Agents on the machines at these clients 90 and 91 upload usage data represented by objects 80 and 82 and 84 for clients 90 and 91, respectively. Distributor 38 may also have usage of his own of R1 and R2, which is uploaded, as represented by arrows 87 and 89, and stored as data objects 86 and 88.

Importantly, in the preferred embodiment, when the server converts usage of R1 and R2 by distributor 38 and his clients for payment by distributor 38 to vendor organization 30, usage represented by objects 88, 86, 84, 82 and 80 is all categorized together and subtotaled by R1 and R2 usage. These usage subtotals are then billed at whatever rate distributor 38 pays for usage or R1 and R2, respectively, regardless of what rate distributor 38 charges client 36 and client 78 for use of R1 and R2. In other embodiments, the distillation process will create metrics for use of R1 and R2 by distributor 38, and separate metrics for use of R1 and R2 by clients of distributor 38 so as to assist distributor 38 in billing his clients 90 and 91.

Each client can have its own license terms which are unique to the client, and the server 20 will convert the usage data gathered (which usage data may be of a different type for each client and dependent upon the terms granted to that client) for each client into a billing statement or usage report based upon that client's license terms regardless of what license terms other clients have. The process of converting usage data into a billing statement or usage report will be referred to herein as distillation. The distillation process for each resource used by each client depends upon the terms of the license for use of that particular resource granted to that particular client by its licensor (which may be the vendor which created the resource or a sub-organization thereof). The terms of each client's license are recorded in a provisioning item data structure in the server. Different provisioning items can contain different licensing terms for the same resource. For example, Microsoft Word might be licensed to large organizations which have many copies at a lower rate for usage than to smaller organizations with fewer copies. Each provisioning item is linked to a resource object such as R1, which may be a single resource or represent a suite of resources such as S1 in FIGS. 4A and 4B.

The distillation process may be done by use of a distillation program (and a CSU distillation program in some embodiments) to convert the raw usage data into metrics and then application of a formula defined by configuration data 105 memorializing the client's license terms to the metrics to develop the bill/report.

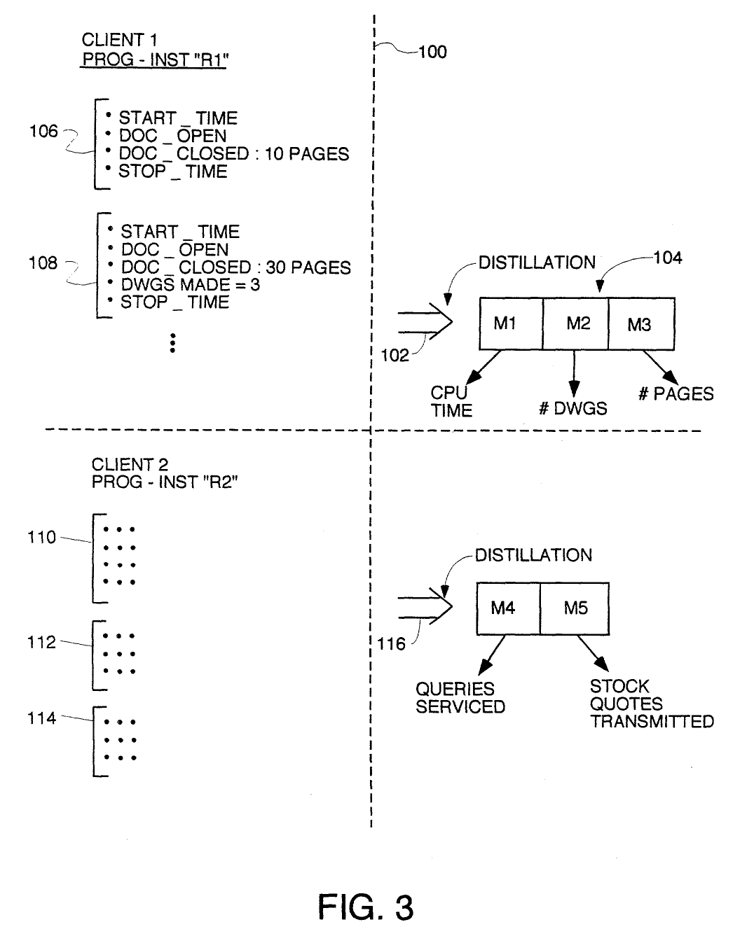

FIG. 3 is an example of how metrics are calculated for two different clients from raw usage data uploaded to the server for each client. On the left side of dashed line 100 is raw usage data recorded by agent programs on computers at the user facilities as various resources are used. This usage data is periodically uploaded (or upon demand in some embodiments) by an automated process over any data path using any communication protocol to the server data structure 22. There, a a distillation process represented by arrow 102 converts the usage data for client 1 to metrics M1, M2 and M3 in box 104. In some embodiments, the distillation process is the same for all resources such as if the only necessary usage criteria is CPU time. However, in other embodiments, the distillation process may be different for every resource depending upon the type of resources it is. For example, the distillation process for a word processor program may summarize the number of pages written and CPU time used, while the distillation process for a CAD program may summarize the number of drawings made and/or the number of objects drawn.

The raw usage data includes entries for use of a resource R1 by client 1 and includes two sessions of use of R1 by client 1 represented by brackets 106 and 108. Each session 106 and 108 has entries for Start_Time, Doc_Open, Doc_Closed: 10 pages (meaning when the document was closed that resource R1 processed, there were 10 pages); and Stop_Time. Session 108 includes all of the same entries but further includes an entry that 3 drawings were made during session 108.

In the particular example of FIG. 3, the distillation process 102 for resource 1 looks at all the raw usage data and develops a metric M1 which is the total CPU time, a metric M2 which is the total number of drawings made and a metric M3 which is the total number of pages generated. The distillation process calculates M1 by subtracting start time from stop time in every session and totalling the results for all sessions. M2 is calculated by totalling the number of drawings made in each session, and M3 is calculated by totalling the number of pages generated in each session. The metrics M1 through M3 developed for client 1 are used for generating billing statements or reports regarding usage by client 1 of resource R1.

The formula to convert metrics 104 into a billing statement or usage report can be the same for all clients in some embodiments, or different for each client in other embodiments. The formula for each client is defined in configuration data stored in configuration data store 105 in FIG. 2. In some embodiments, the distillation process and metrics are eliminated, and raw usage data is processed by a billing and/or report generation process to extract and summarize the necessary data for the bill or report directly from the raw usage data.

Client 2 also has stored in the data structure raw usage data for three different sessions of use of program instances of resource R2. That raw usage data is represented by brackets 110, 112 and 114. A distillation process represented by arrow 116 then converts that usage data to metrics M4 and M5 that are appropriate for the type of resource R2 is and/or the license agreement that client 2 has. In other words, in some embodiments, the distillation process is the same for every resource, but in other embodiments, the distillation process is different for every resource depending upon the type of resource it is. In other embodiments, the distillation process is configurable so as to be a general process, which absent configuration data would summarize the raw usage data into the same metrics every time. Configuration data can be supplied to cause the distillation process to summarize into metrics only the raw data needed for a particular class of license agreements or a particular client. In some embodiments, there is a custom distillation process for each client or a configured instance of the general distillation process which extracts and summarizes only the raw usage data needed for the bill or report for that client.

In some embodiments, the distillation process is unique to each resource but the metrics have common elements such as CPU time as well as metrics which are unique to the type of resource. The formulas used to convert the metrics to usage data, billing amounts or other reports are programmable for each client in this type embodiment.

In other embodiments, the type of distillation process used and metrics generated is dependent upon both the client's license deal and the type of resource used. For example, if R2 is a server that responds to queries by searching a database or provides financial information, metrics M4 and M5 may be based upon the number of search queries serviced, or the number of hits found or the number of stock quotes transmitted.

Once the raw usage data is distilled down to a set of metrics, some common processing may be possible to generate billing statements from the metrics data in some embodiments, but in other embodiments, the conversion formula from metrics to dollar amounts in license fees or other usage report criteria is programmable and unique to each client.

Although a client that uses both resources R1 and R2 is not shown in FIG. 3, such clients who use multiple resources have raw usage data stored in the data structure which reflect the client's usage of all resources the client uses.

Referring to Figures YA and YB, there is shown a more detailed view of the data structure 22 of the server 20 in FIG. 1, modeling a more complex distribution system. FIGS. 4A and 4B also shows the communication paths to agent programs that monitor usage at client facilities. In the preferred embodiment, the database is a single database that records data for the whole distribution structure being modelled. In other embodiments, multiple databases may be used with communication paths and procedures to share information when necessary may be used. An object or table 120 representing organization 1 is linked by pointer 124 to a resource list 122 that contains data that defines the resources declared by organization 1. In the preferred embodiment, each organization is represented by a table with entries that at least give the name of the organization and point to the resource list declared by that organization. The resource list is itself a table which contains entries that list the identification of the list, who owns the list and pointers to other tables that represent the resources on the list.

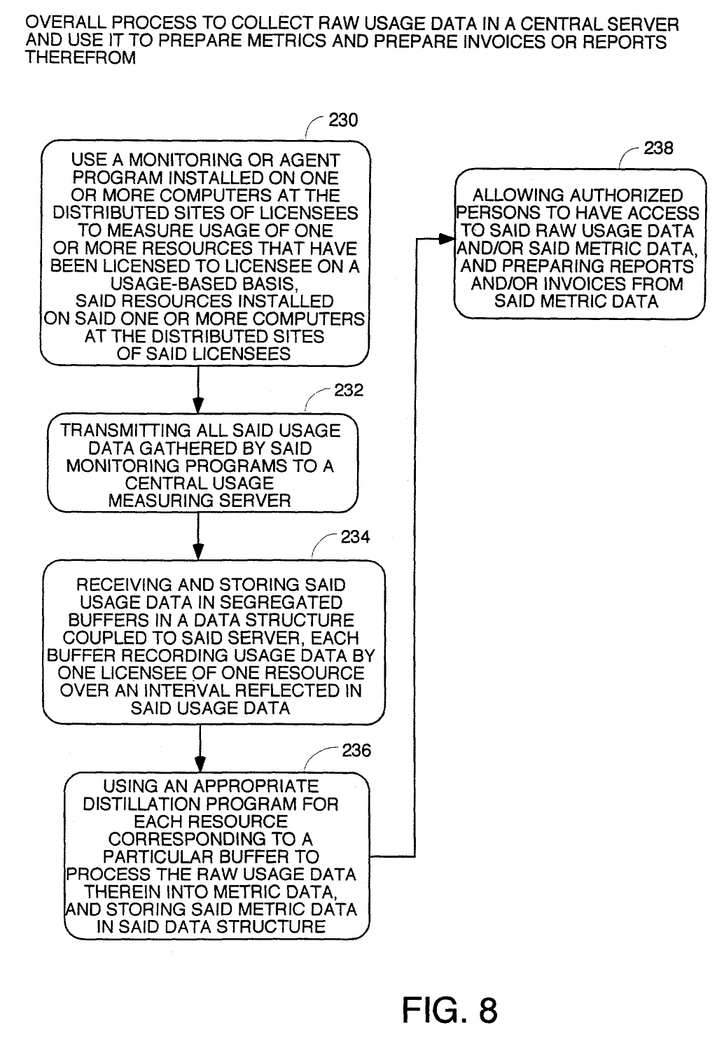

Resources R1, R2 and R3 are declared by their vendor Org 1 by the process shown in FIGS. 9A and 9B (the data that is used to create the data entry Org 1 is also supplied by the vendor Org 1 by the process of FIGS. 9A and 9B). Each resource is represented in a table, and each resource's data table is coupled to its own distillation procedure (usually by a pointer in the table to the starting address of the distillation program), represented by circles D1, D2 and D3 for R1, R2 and R3, respectively. The distillation procedures convert usage data to metrics and is typically a spreadsheet program which has been programmed with programs to sum the raw usage data appropriately and convert it to metrics. Typically, each resource can be represented by a data object or table which will have attributes or rows that define what the resource is, who owns it and a pointer to its distillation process or a procedure call that can be invoked to call its distillation service or process. This data is supplied by the process of FIGS. 9A and 9B. The procedure call is programmable by configuration data in some embodiments so that any one of a number of different distillation processes may be invoked for each resource. Any form of linkage between the resource object and its distillation procedure may be used. In the preferred embodiment, each resource declaration is represented by a table that has rows that list the name of the resource, the resource list to which it belongs and any other necessary information. Likewise, clients and distributors are represented in the data structure 22 as tables with entries that identify the client or distributor, who the vendor is that is licensing access to resources to that client or distributor, pointers to the tables of the resources to which the client or distributor has access, pointers to tables of raw usage data for each resource, and, in the case of distributors, pointers to tables that represent clients or customers of the distributor. Three clients which are licensed to use one or more of resources R1, R2 or R3 are represented in FIGS. 4A and 4B by objects 121, 123 and 125. A distributor Org: Dist 1 which is licensed to distribute and use various resources is represented by object 127. The linkage 164 for Org: Dist 1 shown at 127 means that this distributor can market all the deals represented by items in provisioning list 146. In addition, Org: Dist 1 also supplies resource R6 which, for example, is a program they authored. Clients C4 and C5 of Org: Dist 1 127 are represented by objects 129 and 131, and a sub-distributor 133 of distributor 127 also is shown. These clients 129 and 131 of Org: Dist 1 are licensed to use whatever resources are linked to the provisioning items on provisioning list 166, and sub-distributor 133 is authorized to distribute the resources licensed by the provisioning items on list 166 to his clients. The provisioning items PI 6, PI 7, PI 10 and P 11 are the various marked up license deals that Org: Dist 1 offers on various ones or groups of resources R1 through R6 to its clients and sub-distributors, as explained below. PI 11 is the price item linked to resource R6 which Org: Dist 1 wrote and is distributing to clients.

As an example of how the data structure 22 is used by monitoring agents to determine which resources may be used on a particular computer at a client facility, suppose client computer 126 exists at a client facility somewhere far removed from the central server 20. Suppose also that client computer 126 is a server at an application service provider that is providing access to program resources R1 and R2 to several clients. Suppose R1 is an instance of Oracle database software and R2 is an instance of Synopsis E-Cad software, and suppose clients of the ASP are Goldman Sachs and Intel. Suppose that there is an agent program 130 in execution on computer 126 which monitors which resources are in use by which clients by making periodic calls to operating system 132 to check the current task list. The list of programs on the machine is stored at 134 in memory 136, and the list of authorized clients of the ASP is stored at 138.

The agent 130 needs to know which clients are authorized to have access to which programs. In alternative embodiments, the list of all authorizations of all clients and to which resources they are authorized to have access is downloaded periodically by an authorized resource download process 128 executing on the central server 20. The download is made to all agent programs and is stored in encrypted form locally on the agent's machine such as the store of authorization data at 140. The clients of the ASP do not have access to this data since it is encrypted so there is no chance a client will learn confidential data of another client. In the preferred embodiment however, the agent 130 sends a message to the authorized resource download process 128 through the internet 142 or other data path using the communication and OS layers of machine 132. This message says in effect, “I have the following programs on my machine (list 1), and the following clients (list 2) have access to this computer. Please return the list of all authorizations the clients on list 2 have to the programs on list 1.” Process 128 responds by searching out only the authorizations of list 2 clients to list 1 software. The authorizations so received are stored at 140 in encrypted form. The preferred embodiment requires less data to be sent and stored than the alternative embodiment, but requires more searching and processing time by the central server since every agent of every client will be making similar requests periodically.

The agent then refers to authorization store 140 each time launch of a resource by a client is detected and kills the launch by a call to the OS if there is no authorization for it. Raw usage data is collected by the agent 130 during authorized launches and uploaded to the server 20 over any data path from time to time using the OS and communication layer programs 132.

The raw usage data is stored in the data structure, typically in XML form, and may be collected and uploaded in that form. In other embodiments, the usage data may be translated to XML form or to some relational database form by a translator from whatever form in which it was collected. Each distillation procedure is typically written in XSLT language. In other embodiments, the distillation procedure may be written as a Java applet.

The resource list 122 in Figure YA also includes suites of resources represented by blocks S1 and S2. A suite represents multiple programs collected in a combination, which is usually integrated such as Microsoft Office. However, a suite also may be non-integrated and just be a package of different programs authorized by different vendors, which are commonly all needed by particular businesses. In the example, S1 represents a package of R2, R3 and S2 is a package comprised of R1 and S1. Usages of suites as a whole cannot be measured in the preferred embodiment, and only uses of the individual components can be measured. There may be multiple resource lists, and suites can span resource lists, although they are restricted to one list in the preferred embodiment. Each suite is represented by a table or data object with entries or attributes that point to the tables of the resources in the suite.

In our example, suppose vendor 120 has one small customer, org: C1 shown at 121, and two big customers, org:C2 shown at 123 and org:dist1 shown at 127, which is a distributor that has two different pricing structures for licensing to big and small customers, respectively. To implement this, vendor 120 creates two provisioning lists 144 and 146 in the data structure each of which contains two provisioning items. A provisioning item is a data node or item in the data structure which contains data detailing the terms of a license offer for a particular resource provided by a particular vendor. Different provisioning items can contain different licensing terms for the same resource. For example, Microsoft Word might be licensed to large organizations which have many copies at a lower rate than to smaller organizations with fewer copies. Each provisioning item is linked to a resource object such as R1, which may be a single resource or represent a suite of resources such as S1 in FIGS. 4A and 4B.

The table for vendor organization 120 contains entries, represented by arrows 148 and 150, that point to provisioning lists 144 and 146. The table for org: C1 121 contains a pointer 154 to the small client provisioning list 144. This relationship means that org: C1 121 has access privileges to every resource pointed to by provisioning item PI 1 shown at 135 and PI 3 shown at 137 (sometimes also referred to herein as price items). Each provisioning item is data which records the licensing terms for the resource(s) to which it is linked by a pointer. The tables for org: C2 123 and Org: Dist 1 127 contain pointers to big customer provisioning list 146.

A provisioning item contains data related to pricing or other license terms for use of whatever resource(s) to which it is linked. There is a pointer in the data structure for each provisioning item which points to the resource table or object to which the provisioning item contains licensing terms. Provisioning list 146 for large customers contains provisioning items PI 2 139 and PI 4 141. PI 1 is a table with a pointer entry 143 that points to R1. Likewise, for PI 2 with a pointer 145 that points to R2. The table for PI 1 also contains entries that are used for the formula that converts metrics for R1 usage to billing statements or usage reports for use of R1. The table for PI 3 also contains entries that are used for the formula that converts metrics to billing statements or usage reports for use of R2. However, because a provisioning list is a collection of all the possible deals offered to the particular customer or customers linked to it, PI 3 could also represent a different deal for the use of R1 than PI 1 represents if pointer 145 is pointed to R1 instead of R2. For example, PI 1 might represent a license at one dollar per CPU hour of use of R1 while PI 3 might represent a license at a flat monthly fee of $100 per month plus a usage fee of $0.05 per minute of CPU time for use of R1.

In the particular example shown, PI 3 137 is a table with an entry that points to R2 and contains data that defines the formula for conversion of the metrics of use of R2 by the big customers linked to list 146. PI 4, 141 is a table that points to S1 but could have two pointers to R2 and R3 in alternative embodiments. It also contains entries that define the formula for conversion of the metrics for use of R2 and R3 individually by big customers to billing statements or usage reports. PI 2, 139, even though it points to R1, will have different pricing formula data than PI 1, 135. In fact, PI 2, like all provisioning items, may not have pricing data at all and may simply have data to convert metrics to usage factors needed by a customer for corporate intelligence purposes.

Because org: C1 at 121 has access to both R1 and R2 via provisioning items PI 1, 135 and PI 3, 137, separate usage data collections for use of each resource must be made in the database. This is done by creating authorization nodes 1 and 2, shown at 151 and 152 when the link 154 between org: C1 121 and provisioning list 144 is created. This creation of authorization nodes happens when a customer picks a particular pricing structure and that agreement is memorialized in the data structure by creating an authorization node and setting up a pointer therein (see links 147 and 149) which links the authorization node to the provisioning item under which the license was taken. Each of authorization node representing an existing license and is linked to one or more separate resource authorization nodes, each of which represents one resource licensed on a usage-basis under the license. Each resource authorization node is linked to a usage buffer which records the usage data for the corresponding resource. The resource authorization nodes and usage buffers are created with the authorization node either when the license is taken or sometime thereafter when they are needed such as when the first usage data arrives. In the case of authorization nodes 151 and 152, resource authorization nodes 160 and 162 are created for resources R1 and R2, respectively, and the linkage is established by links 156 and 158. There is a one to one mapping between each authorization node and one resource authorization node in the data structure.

Each resource authorization node is a table which has an entry called a pointer or link in the claims which points to its parent authorization node, e.g., table entries represented by arrows 156 and 158 are pointers to the addresses of the data in the data structure representing authorization nodes 150 and 152, respectively. Each authorization node such as 151 contains a pointer (147 and 149) to the provisioning item that points to the resources for which resource authorization nodes linked to that authorization node have been created and for which usage data is to be collected and stored. The resource authorization nodes function to store data on the usage of the pertinent resource by the pertinent organization. ***Each resource authorization node, i.e., table, also stores or contains a pointer that points to the starting address of a buffer which stores raw usage data uploaded for the agents for use of the resource to which the resource authorization node is linked. The links from the resource authorization nodes to the actual resources for which they store usage data are table entries in the resource authorization node tables that point to the resource table. These links are not shown in FIGS. 4A and 4B to simplify the diagram.

The raw usage data stored in each resource authorization node's buffer is processed by the distillation process for the associated resource and converted to metrics. Thus, in the case of the raw usage data for R1 stored in resource authorization node 160, distillation program D1 153 processes that raw usage data to generate metrics M1, M2, etc. shown at 192. Likewise, distillation process D4 155 processes the raw usage data in resource authorization node 186 to generate the metrics shown at 194. Similarly, for every other raw usage buffer, the distillation program coupled to the resource to which the raw usage data buffer corresponds is used to generate metrics. The vendors of the resources write these distillation programs so as to be compatible with the type and format of data collected by the agents at the user facilities. All usage data for that resource, regardless of which customer made the use, is distilled by the same distillation program into the same type of metrics even though the actual values of the metrics will be customer dependent and based upon the amount or type of use.

Org: Dist 1 127 also has an authorization node 176 which is linked to provisioning item PI 10 157 by link 178. PI 10 is linked to each of resources R4, R5 and R6 by links that are only symbolized by a stub arrow 265. Authorization node 176 is linked to each of three resource authorization nodes 180, 182 and 184. Each of these nodes is linked to a single raw usage data buffer, represented by buffer 186 to record usage data for resource R4 by Org: Dist 1, buffer 188 to record usage data for resource R5 by Org: Dist 1, and buffer 190 to record usage data for resource R6 by Org: Dist 1.

Separate resource authorization nodes are needed because a customer like org: C2 123, which has access to resource R1 via provisioning list PI 2 and R2 and R3 via provisioning list PI 4 needs to record usage data for R1, R2 and R3 separately even though there are only two provisioning items in the provisioning list to which the authorization node (not shown) for org: C2 123 is linked.

The raw usage data uploaded by the agent programs all over the world is stored in the buffers which are part of or pointed to by these resource authorization nodes. Thus, the vendors and distributors can gather usage data for all of their products from one place and are decoupled from the need to know addresses and access protocols of nodes on user networks all over the world.

Nodes 160 and 162 store only the raw usage data of resources R1 and R2, respectively, by org: C1. Raw usage data upload messages include the organization where the agent is executing, the resource reported on, as well as the collected usage data. Each resource authorization node is linked by data entries (not represented in FIGS. 4A and 4B) to the actual resource for which it stores data.

An upload process which is part of process 128 or a separate process (not shown) receives the upload messages and finds the correct resource authorization node buffer and stores the raw usage data in it.

The linkage 164 for Org: Dist 1 shown at 127 means that this distributor can market all the deals represented by items in provisioning list 146. In addition, Org: Dist 1 also supplies resource R6 which, for example, is a program they authored.

Suppose also that there is an organization 2 represented by table 168 that has declared a provisioning list 170 containing provisioning items PI 8 and PI 9 which are linked to resources R4 and R5 on a resource list 169. Org: Dist 1 has been granted access to use and/or distribute resources R4 and R5 by virtue of linkage 172 to provisioning list 170. Thus, Org: Dist 1 can market deals on resource R6 and all the resources pointed to by price items on provisioning lists 146 and 170 (resources R1 through R5).

The linkage 164 means that Org: Dist 1 can establish its own provisioning list 166 which contains provisioning items PI 6 and PI 7 to market resources R1, R2 and R3. Provisioning items PI 10 is a deal Org: Dist 1 is offering on resources R4, R5 and R6, and PI 11 is a package deal Org: Dist 1 is offering on resources R1 through R6. The price item PI 2 shown in dashed lines at 174 and the dashed line to PI 6 means that Org: Dist 1 has established his own price item, PI 6 to resell the resource represented by PI 2. This is how distributors can mark up the prices on resources they obtain from org 1 shown at 120. In other words, all these provisioning items PI 6 and PI 7 represent the marked up deals the distributor offers on resources R1 through R6. Further, PI 6 through PI 11 can also represent different packaging of these resources than the parent provisioning items represent. Linkage 172 means Org: Dist 1 can also market R4 and R5 (not shown) using deals represented by provisioning items PI 10 and PI 11 representing markups of the deals represented by PI 8 and PI 9.

Org: Dist 1 has three clients org: C4, org: C5 and org: dist 2 all of which have been granted access to R1-R5 via provisioning list 166. Each of these organizations has an authorization node (not shown) and a resource authorization node (not shown), each linked to particular provisioning item on list 166 and a particular resource for storing raw usage data for that resource. Org: C2 and org: C3 also have links to provisioning lists 146 and 170, respectively and have their own authorization nodes and resource authorization nodes (not shown).

Each of Org: Dist 1 and org: dist 2 may also declare their own resource lists with resources that they authored or own and which can be offered alone or packaged with resources R1-R5 on the provisioning lists of these distributors.

One of the advantages of the data structure of FIGS. 4A and 4B is that it de-couples the vendor organizations from the complexity of having to gather usage data from the computers of users all over the world and/or from distributors all over the world. The automatic uploading of usage data from agents coupled with the data structure of FIGS. 4A and 4B coupled with the distillation and billing/report generating processes of the server 20 take all the difficulties away for the vendors. The raw usage data for the resources each vendor provides will be gathered for them, the data will be summarized and billing statements will be sent. The money collected will then be forwarded to the vendors. Likewise, the data structure 22 is a good source of corporate intelligence for both vendors as to sales and uses of their products as well as for users who may want to know how much they are using particular resources for purposes of management decisions regarding whether to buy the resource or search for a better deal.

Query interface program libraries (not shown) control server 20 to receive queries from vendors and users and to search the metrics or raw usage data to respond to the queries and transmit messages back to the inquirers with answers to their questions. The query interface programs block access to any confidential metric or raw usage data not belonging to or to which rightful access can be made by the vendor or user who made the query. This implements security firewalls so that distributors cannot learn usage data of other distributors or metrics reported by other distributors and vendor organization cannot access raw usage data or metrics of any entity other than their own customers and distributors. These security firewalls are filters that are built into queries and which filter out any inappropriate data from data reported back in response to a query.

The data structure shown in FIGS. 4A and 4B is like a tree that grows upward. The raw usage data of user organizations stored in the resource authorization nodes are the trunk of the tree. The data in the data structure 22 representing this tree can be traced upward from raw user data at any level in the heirarchy through an authorization node(s) to corresponding client or distributor organization(s) to corresponding price item(s) on corresponding provisioning list(s) to corresponding resource(s) on resource lists to corresponding vendor(s) that supply the resources. One can think of the resources as the leaves of the tree.

Process to Programmably Map Between Raw Usage Data and Metric Data Using a Distillation Program Pointed to by Configuration Data

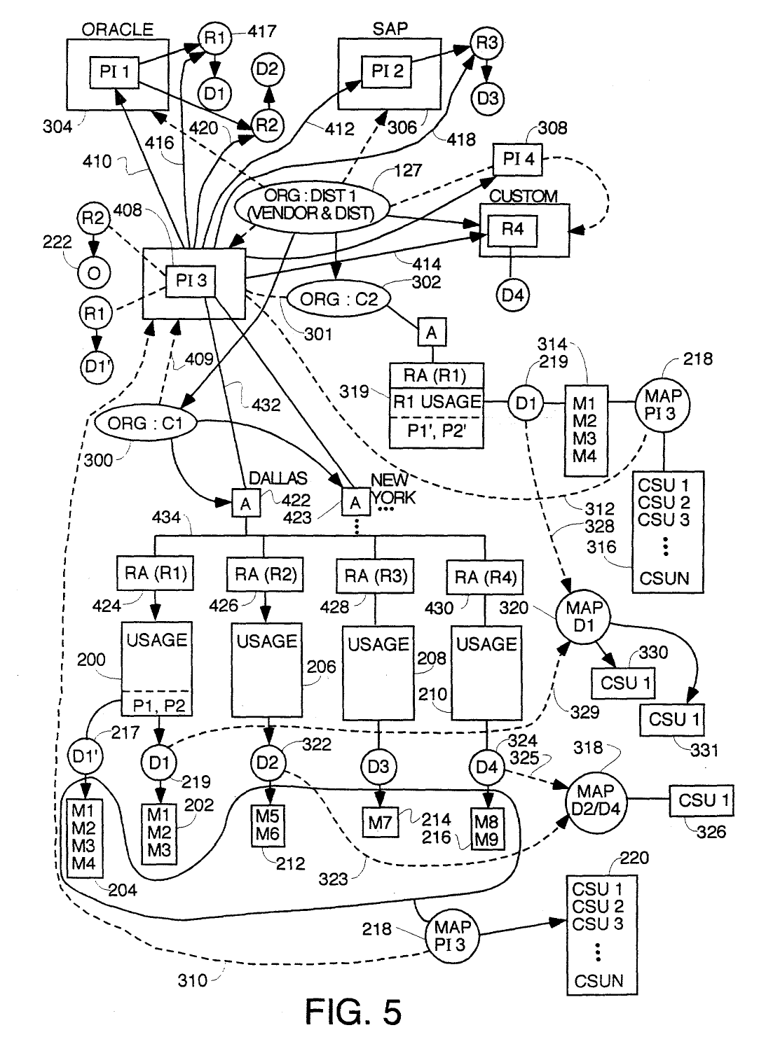

FIG. 5 is another example of a data structure that could be maintained by the server 22 for just the data pertaining to an entity Org: Dist 1 at 300 who is both a vendor of another organization's resources R1, R2 and R3 and a distributor of its own resource R4. FIG. 5 also illustrates how a CSU distillation program can convert metrics to CSU units such as dollars. FIG. 5 also illustrates how a customer such as Org: Dist 1 can create his own distillation procedure to augment, supplement or replace the distillation procedure defined by the creator of the resource. In the data structure illustrated in FIG. 5, Org: Dist 1 is a vendor and a distributor who distributes resources R1, R2 and R3 provided by other vendors and who also distributes resource R4 authored by Org: Dist 1. Resources R1, R2 and R3 each have distillation programs D1, D2 and D3 provided by the authors of those programs. Org: Dist 1 also authors a distillation program D4 for R4.

R1 and R2 are distributed under the licensing terms of provisioning item PI 1, and R3 is distributed under the licensing terms of PI 2. Resources R1, R2, R3 and R4 are also licensed as a package from Org: Dist 1 to Org: C1 under the licensing terms of provisioning item PI 3. The rights of Org: C1 to use the resources pointed to by PI 3 at 408 are reflected in the data structure as pointer 409. Another client Org: C2 at 302 also has the rights to use the resources pointed to by PI 3 as indicated by pointer 301. Pointers 301 and 409, in some embodiments, are more than pointers and can contain data to customize for each customer 300 and 302 the distillation process from usage data to metrics or from metrics to CSUs. For example, pointer 409 may be an entry in a table that says user 300 has access to provisioning item 408 with further entries which are or point to an XML fragment that contains cusomization data which can be used anywhere downstream. Such customization data may include the customer's zip code, average monthly usage volume, some constant which will modify a term in a distillation program formula or CSU distillation program formula, etc. Then when a CSU distillation program which is part of the provisioning item or pointed to by it is executed on a particular customer's metrics, the data contained in the customer's pointer to the provisioning item can be used to customize the CSU distillation process. The same holds true for customization of a distillation process pointed to by a resource entry which, in turn, is pointed to by the provisioning item.

Suppose that Org: Dist 1 wants to have more metrics generated about the usage of R1 by Org: C1 and any other clients that license R1 through PI 3 than are provided by distillation program D1 defined by the provider of R1. Distillation program D1 generates metrics M1, M2 and M3 stored in metrics data node 202 from raw usage data stored in buffer 200.

However, distillation program D1 is not adequate for the purposes of Org: Dist 1. Org: Dist 1 wants metrics M1, M2, M3 and M4 for usage of R1 by Org: C1 and any other of its clients that license R1 under provisioning item PI 3. To accomplish this, Org: Dist 1 authors a new distillation program D1′ shown at 217 which takes raw usage data reported by the monitoring agent at client Org: C1 stored in usage node 200 and generates therefrom metrics M1, M2, M3 and M4. This distillation program D1′ is typically just a spreadsheet program which is part of the server side data structure or pointed to by a pointer therein. This spreadsheet is part of the relationship between PI 3 and R1, and typically there will be a pointer linking PI 3 to the beginning address of program D1′ in some manner which will cause D1′ to be used whenever metrics for R1 usage are to be generated. In an alternative embodiment, the data entry for R1 will contain a pointer to distillation program D1 and another pointer to distillation program D1′, and configuration data linked to or part of the data entry for each entity licensed to use or distribute R1 will determine which distillation program to run. The spreadsheet has had its formulas programmed by Org: Dist 1 to use the usage data in usage node 200 as the variables and to calculate metrics M1, M2, M3 and M4 therefrom. The mapping between raw usage data and the resulting metrics can be anything defined by the formulas and can be changed by changing the formulas.

In some embodiments, DI′ may be configured to be used for some customers that license under PI 3 and not used for other customers which license under PI 3. In other embodiments, the relationship to D1′ may be configured to always override processing by DI for all customer licensing of R1 through PI 3. For the raw usage data in buffer 200 representing usage of R1 by Org: C1, the operation of D1′ results in the calculation and storage of metrics M1 through M4 in metrics node 204. If D1′ was “turned off”, D1 would execute and reduce raw usage data 200 for usage of R1 to metrics M1 through M3 in node 202. Typically, D1′ can be turned off and D1 turned on by setting the pointer in the provisioning item to point to distillation program D1 shown at 219 instead of D1′. Alternatively, all provisioning items can contain pointers to a table in configuration data which has one column comprised of rows that identify the various usage data buffers in the system and another column having rows which contain a pointer to the proper distillation program for each usage data buffer. In this embodiment, when D1′ is to be turned off, the pointer associated with usage data buffer 200 may simply be changed to point to D1 instead of D1′.

PI 3 is also linked to R2 and R2 is linked to a null value 222 for the distillation program for PI 3 licensees. This null value means that usage data for R2 by PI 3 licensees is to be reduced to metrics through distillation program D2.

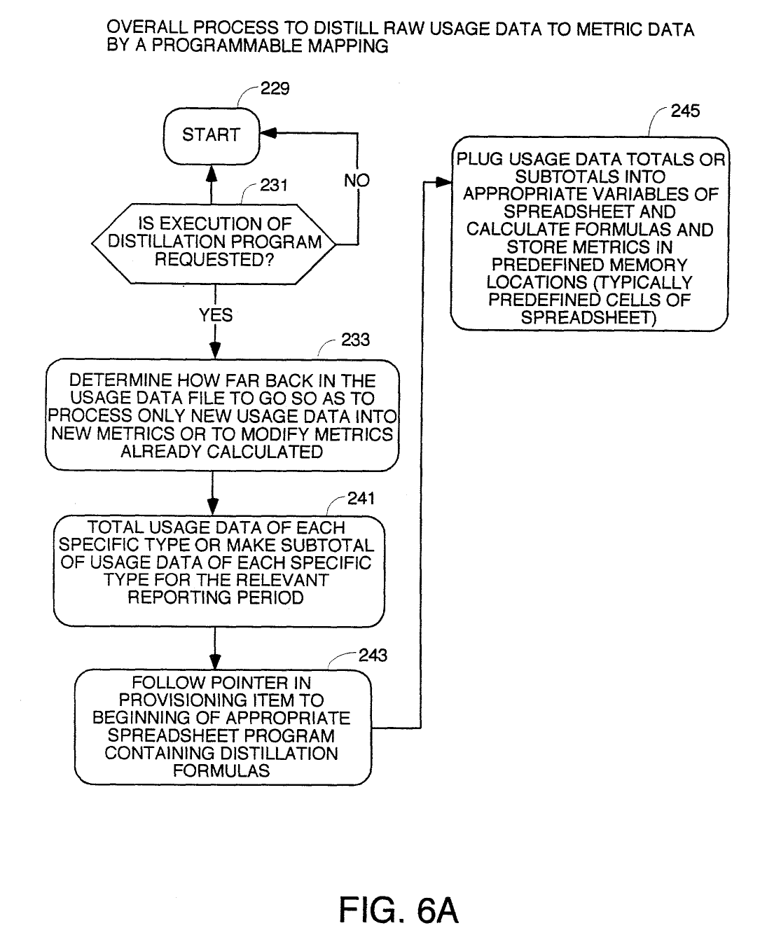

FIG. 6A is a flowchart of the process carried out by any distillation program to map between raw usage data and metrics using a programmable mapping. The process of D1′ would be the same and the only difference would be whether the system vectors processing to distillation program D1 or D1′. That vectoring can be controlled by configuration data that turns off D1 and turns on D1′ either on a permanent basis or on some criteria That embodiment is represented by FIG. 6B.

In FIG. 6A, the process starts at step 229 Step 231 represents the process of determining whether it is time for the distillation program to run. In some embodiments, the distillation program is only run when requested manually by the operator. In other embodiments, the distillation program is run once per day. In still other embodiments, the distillation program is run whenever new raw usage data has arrived. In this last embodiment, step 231 represents a test to determine if new usage data has arrived yet and causes launch of the distillation program whenever new data has arrived. This can be accomplished in any way such as by checking a flag which the server sets each time the server receives an upload of new usage data from an agent program. There can be a single flag which is set each time any new upload is received with the distribution program comparing the old usage data file size at the time the distillation program was last run to the current usage data file size of the appropriate usage data file, and if the new file size is larger, then new usage data has been achieved. A more preferred embodiment has a flag for every raw usage data file in the system, and each time new usage data is received, the flag for the usage data file into which the usage data is written is set. The YES path out of step 231 represents both embodiments and any other embodiment where the fact that new data has arrived is determined in any way.

Step 233 represents the process of determining how far back in the usage data file to go so as to process only new usage data into new metrics or to modify metrics already calculated based upon the new usage data. This can be accomplished in any fashion including setting a pointer in a FIFO or LIFO buffer at the end of the data each time data is written into the buffer. In some embodiments, each new batch of data has its own pointer which stays set at the end of the addresses containing that data batch. Then when new data is written into the buffer, the distillation program starts at the pointer at the end of the last batch and processes only the new data written into the buffer between the pointer set for the previous batch of usage data and the new pointer set for the new batch of data. In other embodiments, only one pointer is used, and when each new batch of usage data is stored, the pointer is moved and a notation of the address range in which the new data was stored is made. This notation is then used in the processing of step 233 so that only the new data is processed.

Step 241 represents the process of subtotaling the usage data of each specific type or making a subtotal of the usage data of each specific type for the relevant reporting period. Typically, this step will be accomplished by adding up the new usage data of each specific type and adding that total to the running total previously calculated for usage data of that specific type. Configuration data may be used in some embodiments controlling the process of step 241 to do things like specify what the relevant reporting periods are for each type of usage data, and whatever other configuration data is useful or necessary for the proper calculation of metrics.

Step 243 represents the process of following a pointer in the provisioning item to the beginning address of an appropriate distillation program. Typically, the distillation programs will be spreadsheet programs which contain the distillation formulas to convert usage data into metrics. Typically, the totals developed in step 241 are programmed into the variables of the distillation program spreadsheet formulas, and then the formulas are calculated to yield the metrics. The metrics will then be stored in predetermined cells of the spreadsheet per conventional spreadsheet usage. This process of plugging the usage data totals or subtotals into the appropriate variables of the spreadsheet and calculating the formulas and storing the metrices in predefined memory locations or spreadsheet cells is represented by step 245..

FIG. 6B: Configuration Data Controls Selection of Distillation Program

Referring to FIG. 6B, there is shown a flowchart for a process to distill raw usage data to metric data by a programmable mapping using whatever distillation program is pointed to by configuration data such that alternative distillation programs may be used for some clients or in other special circumstances defined by configuration data. The process flow of FIG. 6B is such that certain distillation programs can be used for some clients and other distillation programs, perhaps authored by the clients themselves or otherwise custom tailored for one or more clients can be used for those clients, all controlled by the programmable content of configuration data.

The program of FIG. 6B is repeated for each usage data buffer, so it may be repeatedly called, once for each usage data buffer in the system or whenever new usage data is stored in any usage data buffer. The program starts at step 229, and in 231, a determination is made whether new usage data has arrived by checking the new data flag for the pertinent usage data buffer. Step 233 determines how far back in the usage data file to go so as to process only new usage data into new metrics or to modify or update metrics already calculated to take into account the new usage data. This is typically done by checking the position of a pointer which is placed at the last address in a file containing the last item of data from the last batch of updates and comparing that to the position of a pointer at the end of the latest batch of usage data. The usage data between these two pointers is the new usage data. Step 235 represents the process of determining the usage data totals for each specific type of usage data, or calculating a subtotal of just the new usage data of each specific type or calculating the total usage data for a specific reporting period. How exactly the new usage data is used such as whether it is separately summed and used alone or whether it is summed and then that total is combined with the previously calculated running total for usage data of that type for that particular resource by that particular client (or any of the above for only a specific reporting period) depends upon the resource and the type of usage data and the requirements of the client or license deal for that client. Steps 233 and 235 are intended to represent the appropriate processing for whatever the distillation process is for a particular resource or for a particular client or for the particular type of usage data. There are too many different possibilities for how various types of usage data of various types of resources can be processed and used to list or show them all here, but those skilled in the art will understand how to implement any of these variations.

Test 247 determines whether there is configuration data controlling the selection of a distillation program? This can be done in any way. Typically, this is done by reading the provisioning item that controls the license terms of the resource for which usage data is to be processed and determining if a pointer in the provisioning item points to a distillation program itself or points to a table of configuration data. The NO branch out of test 247 represents the case where the pointer in the provisioning item does not point to any configuration data and points directly to a distillation program. Step 249 represents the process of simply following the pointer to whatever distillation program contains the appropriate distillation formulas for this resource's usage data. Step 238 is a repeat of process 238 in FIG. 6A wherein the usage data totals for usage of each type are plugged into the appropriate variables of the distillation program's spreadsheet formulas, and the spreadsheet's formulas are calculated to yield the metrics. These metrics are then stored in the appropriate cells of the spreadsheet.

The YES branch out of test 247 represents the case where the provisioning item has a pointer which points to configuration data. This configuration data can take any form such as by a table that contains a column having individual rows, each containing data identifying a specific usage data buffer, and having another column containing rows, each row corresponding to a particular usage data buffer containing a pointer to the appropriate distillation program for that usage data buffer. Step 251 represents the process of using the identity of the usage data buffer being processed to find the correct row in the configuration data table. Once the right row is found, the pointer associated with that row, i.e., the specific usage data buffer mapped to that row, is read. Processing then flows to step 249 and thence to step 238 where processing proceeds as previously described.

The ability for each distributor to define their own distillation program allows great flexibility in encoding the terms of very complex licensing structures into the server data structure. Note also that the execution of distillation program D1′, 217 in FIG. 5, does not affect any other metrics in the data structure for use of R1 or any other resource by different clients. Raw usage data for those other clients for R1 and other resources is not processed by D1′.

Usage data for R2, R3 and R4 by Org: C1 is stored in raw usage data buffers 206, 208 and 210, respectively. Execution of distillation programs D2, D3 and D4 on these raw usage data buffers, respectively, results in metrics stored in metrics nodes 212, 214 and 216, respectively.

In an alternative embodiment, the server can determine which distillation program to use to process each buffer of raw usage data by following pointers in the raw usage data buffer itself that point to the correct distillation program to use. In still other embodiments, multiple pointers that create a path can be followed to the correct distillation program. These pointers make a path from the buffer of usage data to the corresponding resource authorization node to the corresponding authorization node and from there to the provisioning item and thence to the resource corresponding to the provisioning item. From the resource data structure itself, there is a pointer that points to the correct distillation program for that resource.

Programable Mapping Between Metrics and CSUs Such as Dollar Amounts or Usage Reports

FIG. 5 also represents a mapping process to map metrics data into central service units by a programmable mapping. Some customers do not need to know the individual details of their usage of each resource at the level presented by the metrics and prefer to have all their usage summarized in one or more units of measure of their choosing. These units of measure of their choosing will be called central service units (CSU) herein. A CSU might combine all usage of all programs based upon any criteria into one dollar amount per month (or any other group of one or more numbers that make sense to a client), or might combine all usage of programs of a first class into execution units of some sort and all usage of programs of another class into a monthly dollar amount. The point is that the CSU can be programmably defined by the customer or the customer's distributor in any way they want that makes sense for one particular customer's accounting system or corporate intelligence/management needs or for all customers licensed under a particular provisioning item. This is done by defining the formulas in a mapping or CSU distillation program that converts metrics to CSUs. FIG. 5 illustrates a data structure where a single mapping program 218 linked to a single provisioning item converts the metrics of two different customers to CSU units using the same formulas. The CSUs will be different because each of the two customer's usage and metrics are different, but the same formulas were used.

CSU buffer 220 is just a specific area of memory reserved to store the CSUs generated by CSU distillation program 218 for Org: C1. This mapping program feature allows simplification of numerous metrics into simpler units of measure. The mapping program 218 is just a spreadsheet program in the preferred embodiment where the formulas are defined by Org: Dist 1 to convert metrics for usage by Org: C1 of resources R1, R2, R3 and R4 into units of measure represented by a plurality of central service units CSU1, CSU2, CSU3. The formulas are recorded in the spreadsheet to implement the mapping between metrics and CSUs that Org: C1 desires.

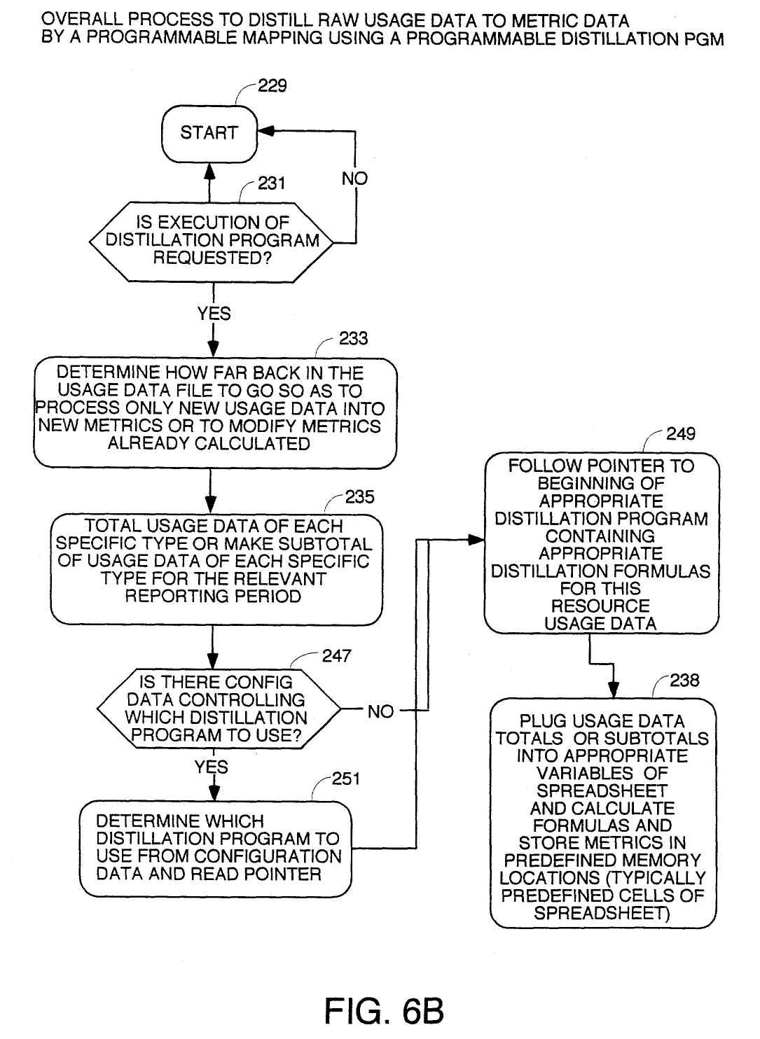

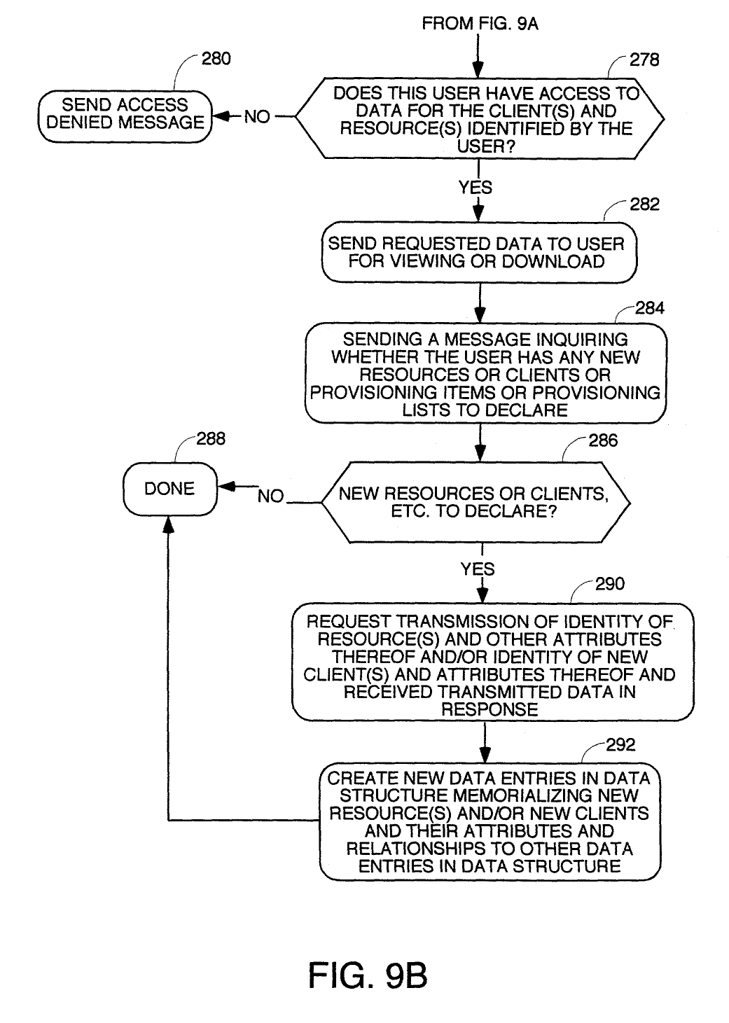

FIG. 11 is a flowchart of the process to use a CSU distillation program linked to every provisioning item to do metric to CSU conversion for all customers licensed under that provisioning item using the same formulas. FIG. 11 is identical to FIG. 7 except for step 404. Step 404 represents the process of following a pointer in the provisioning item to the proper CSU distillation program (or just executing the CSU distillation program that is part of the provisioning item data structure). Thus the process in this embodiment is:

10. using a distillation program to convert usage data of a client for a particular resource to metrics (253);

11. when it is time to run a CSU distillation program for this client (can be manually triggered, scheduled or automatically triggered when new metrics are stored), following pointers from the usage buffer up through the resource authorization node and authorization node to the provisioning item under which the use is licensed and following a pointer from that provisioning item to the CSU distillation program linked to that provisioning item and launching the CSU distillation program (404, 257);

12. following pointers to or otherwise retrieving the correct metrics and licensing terms and plugging that data into the formulas in the CSU distillation program (257) and doing an integrity check to make sure all the necessary metrics have been calculated and are plugged into the appropriate formulas at the appropriate locations (257, 259); and

13. recalculate the formulas with the new values for the variables thereof derived by plugging in the new metrics (261).

Steps 400 and 402 are only performed if there is no pointer in the provisioning item to a CSU distillation program.

Mapping program 218 in FIG. 5 (also called a CSU distillation program in the claims) is defined by the customer Org: C1 or its distributor Org: Dist 1, but since it will be used for both customers 300 and 302, it typically is defined by Org: Dist 1 127. The mapping program 218 is linked to or part of provisioning item PI 3 which represents the terms of the license under which the use is made by both customers 300 and 302. PI 3 are terms of usage for each of resources R1 through R4 which are marked up from the terms presented by provisioning items 304 and 306 under which distributor 127 takes his license and provisioning item 308 for resource R4 that distributor 127 authored. PI 3 represents terms by which any of R1 through R4 may be used. This linkage between mapping program 218 and PI 3 is represented by links 310 and 312. The mapping program 218 is authored by Org: Dist 1 to serve the specific needs of Org: C1 and the other customers of Org: Dist 1. The mapping program 218 functions to summarize all the metrics of usage by Org: C1 of resources R1, R2, R3 and R4 and all the usage by Org: C2 at 302 of resource R1. Org: C1's metrics 204, 212, 214 and 216 are summarized by mapping program 218 into units of measure represented by a plurality of central service units CSU1, CSU2, CSU3, CSUn shown stored in central service unit node or buffer 220. Org: C2's usage metrics at 314 are summarized into the CSUs stored at 316.

The mapping program 218, in the preferred embodiment, is part of the provisioning item PI3, so all licensees under the terms of PI3 have their metric data converted by the same formulas in mapping program 218 to CSUs.

In alternative embodiments, each distillation program for a particular resource has a pointer therein to a different mapping or CSU distillation program. This embodiment allows customers to have different CSU distillations based upon the different resources they use. In In other words, everybody using resource R1 will get one type of programmable distillation using the same formulas in mapping program 320 to convert from metric to CSU whereas everyone using resource R2 will get a different distillation using the same formulas in mapping program 318. This embodiment is represented by mapping programs 318 and 320 in FIG. 5. The mapping program 318 is linked to distillation programs 322 and 324 by links 323 and 325 and generates CSU1 at 326 for all customers using resources R2 and R4 (which in the example is only customer 300). A different mapping program 320 is linked by links 328 and 329 to distillation program 219 so as to convert metrics generated by all customers who use resource R1 to CSUs. Mapping program 320 generates CSUs at 330 for customer 302's use of R1, and generates CSUs at 331 for use of R1 by customer 300. Of course, in this embodiment, different customers using the same resources would share the same mapping program to CSUs by virtue of sharing the same distillation program. The process the usage measuring server performs to calculate the metric data, determine if the distillation program used has a pointer to a CSU distillation program, follow that pointer if it exists and use the CSU distillation program to calculate CSUs is disclosed in FIG. 7, discussed below.

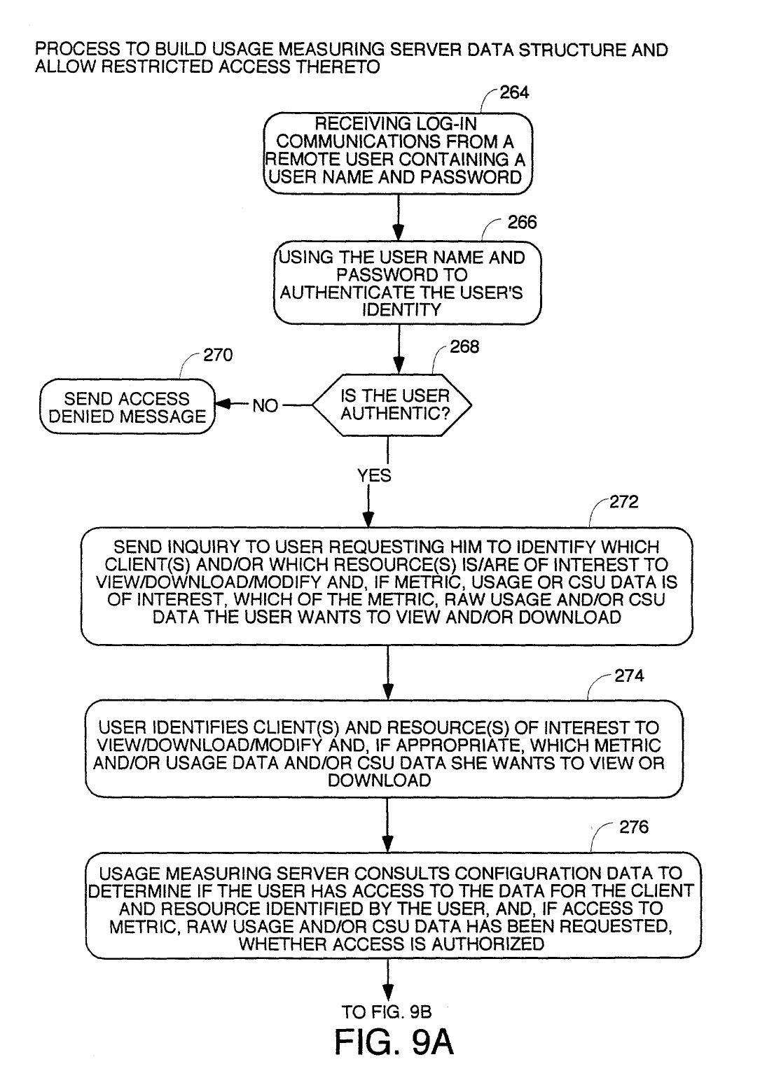

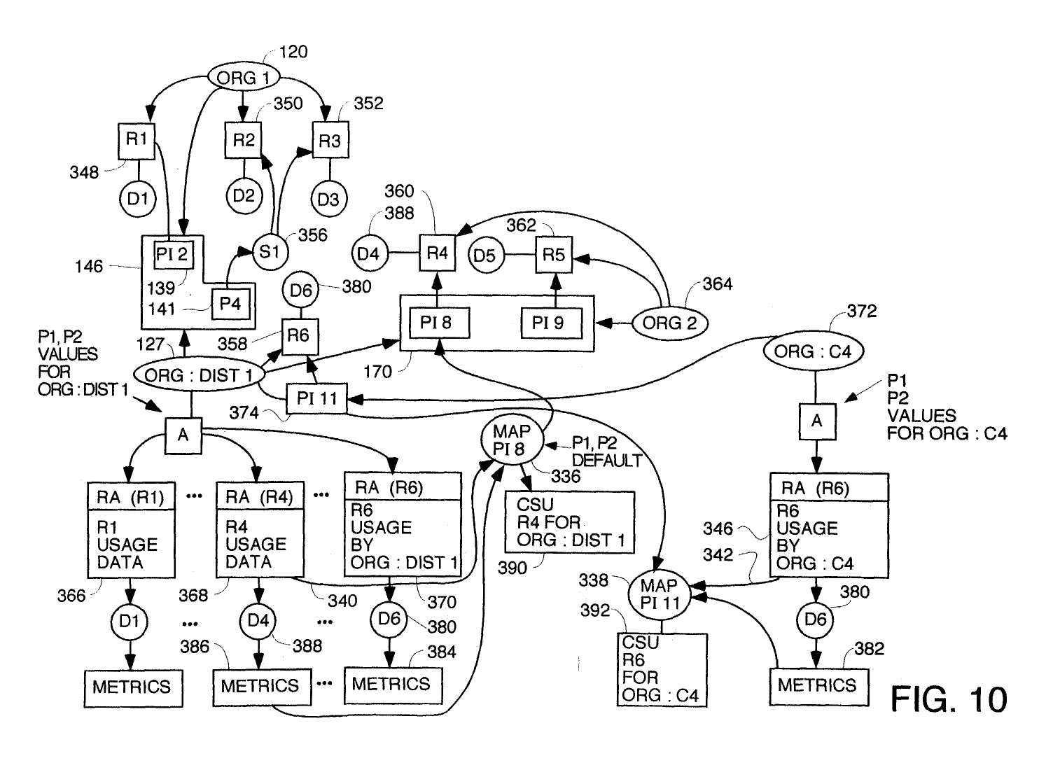

In an alternative embodiment, the above described pointers from the distillation programs to the CSU distillation programs are used and the same formulas in the CSU distillation programs are used for every client using the particular resource to which the distillation program is coupled. The difference between this alternative embodiment and the embodiment described above using mapping programs 318 and 320 is that different customers can alter constants in the formulas using data stored in their usage buffers. An example of this is shown as constants P1 and P2 stored in R1 usage buffer 200 for customer 300's use of R1 and different constants P1′ and P2′ stored in usage buffer 319 storing usage data for usage by customer 302 of R1. These constants may be based upon the volume of usage of a particular customer so as to apply volume discounts or may be used to implement any other incentive, surcharge etc. When CSU distillation program 320 is triggered to process the metrics generated by the D1 distillation program 219 from usage buffer 200 for customer 300, the server is programmed by CSU distillation program 320 to read constants P1 and P2 from the usage buffer and substitute them into the appropriate formulas of program 320 before evaluating the formulas. However, when CSU distillation program 320 is launched by D1 distillation program 219 after processing the usage data for customer 302 in usage buffer 319, the CSU distillation program 320 controls the server to read the constants P1′ and P2′ from buffer 319 and substitute them into its formulas thereby changing the outcome of the formulas even if the usage data had been the same. A process to implement metric to CSU conversion using custom constants for at least some customer who want CSU based reports is shown in FIG. 12. This figure also illustrates the alternative embodiment for server processing using the data structure of FIG. 10 where the pointers to the CSU distillation programs are stored in the usage buffers. This embodiment will be described below.

In the alternative embodiment represented by the data structure of FIG. 10, each customer could have a custom mapping from metrics to CSUs by virtue of having the pointer to the mapping program stored in that customer's raw usage data buffer(s) which are not shared by other customers. This is implemented by mapping programs 336 and 338 which are each different and which are pointed to by pointers 340 and 342 in usage data buffers 344 and 346 of different customers such that each customer gets a different programmable distillation from metrics to CSUs for their use of whatever resource that is mapped to the buffer of that customer's usage data which contains the pointer to that customer's mapping program. FIG. 10 shows a data structure wherein distributor 127 has a license under the provisioning items 139 and 141 on provisioning list 146 to resources R1 through R3 (348, 350 and 352) offered by vendor 120 with R2 and R3 offered as a suite 356. Distributor 127 also has a license under provisioning list 170 to resources 360 and 362 offered by vendor 364. Vendor 127 uses resources R1 through R6 and usage data for this use is collected in usage buffers 366, 368, 344 and 370, respectively. Vendor 127 also offers resource R6 which it authored and shown at 358 to other customers for licensing, and customer 372 has taken such a license under the terms of provisioning item 374. The usage data for customer 372's use of R6 is collected in buffer 346. The data item 358 representing R6 declared by distributor 127 points to a distillation program D6 shown at 380 which generates metrics at 382 for customer 372 and metrics at 384 for customer 127's use of R6.

Now, suppose distributor 127 wants a certain CSU distillation of the metrics at 386 generated by distillation program D4 at 388 generated from the usage data in buffer 344 which represents distributor 127's use of R4 360. The data item 360 representing R4 points to distillation program D4 at 388 and this programmable spreadsheet program is used to generate metrics 386. But usage data buffer 344 (which is not shared by any other customer or distributor) also contains a pointer 340 to mapping program 336. This mapping program 336 runs when manually launched or on a configurable schedule such as once per day or automatically whenever new metrics are stored in buffer 386. Whenever mapping program 336 runs, it reads the appropriate R4 metrics from buffer 386 and the licensing terms from PI 8 on list 170 and plugs these data into the proper variables of the programmable formulas in the spreadsheet or other program of mapping program 336 and then calculates the formulas to yield the CSUs stored in buffer 390. Likewise, mapping program 338, which has different formulas from mapping program 336, when called into execution by any of the aforementioned means, reads the metrics stored in buffer 382 by D6 and reads the licensing terms defined by provisioning item 374, and plugs the data so acquired into the proper variables of its spreadsheet or other programmable formulas. The resulting CSUs are stored in buffer 392.

FIG. 12 is a flowchart of the process carried out by the usage-measuring server 20 to convert metrics to CSUs using a different CSU distillation program for every user if so desired. The basic difference between the process of FIG. 12 and the process of FIGS. 11 and 7 is that the CSU program to use is found by following a pointer in the usage data buffer rather than in the distillation program or the provisioning item. This difference is seen at step 406. FIG. 12 is identical to FIG. 7 except for step 406. Step 406 represents the process of following a pointer in the usage data buffer that generated the metrics being process, said pointer pointing to the proper CSU distillation program. Thus the process in this embodiment of FIG. 12 is:

10. using a distillation program to convert usage data of a client for a particular resource to metrics (253);

11. when it is time to run a CSU distillation program for this client (can be manually triggered, scheduled daily or at some other interval or automatically triggered when new metrics are stored), following a pointer in the usage buffer storing the usage data which was processed in step one into metric data to the correct CSU program to use if such a pointer exists (406);

12. following pointers to or otherwise retrieving the correct metrics and licensing terms and plugging that data into the formulas in the CSU distillation program (257) and doing an integrity check to make sure all the necessary metrics have been calculated and are plugged into the appropriate formulas at the appropriate locations (257, 259); and

13. recalculate the formulas with the new values for the variables thereof derived by plugging in the new metrics (261).

Steps 400 and 402 are only performed if there is no pointer in the provisioning item to a CSU distillation program.

Referring to FIG. 7, there is shown a flowchart of the process to programmably map between raw usage data and metric data and then to programmably map from the metrics to Central Service Units or CSUs. Step 253 represents the process of converting raw usage data to metrics. This can be the process of FIGS. 6A or 6B, or any other process suitable to detect when new usage data has been stored, sum the usage data of each type for a particular reporting period or other report format, and use that usage data to calculate metrics according to some formula defined by the user, the distributor or the provider of the resource.

Step 255 represents the process of determining whether the distillation program used to generate the metrics contains a pointer to a CSU distillation program. If not, step 400 is performed which actually is a do nothing even where the metrics are left alone, and then transition to step 402 occurs where the usage measuring server waits for the next launch of the distillation program. In some applications, a CSU distillation program will need only the metrics generated by a single distillation program while in other applications, a CSU distillation program will need the metrics generated by multiple different distillation programs. An example of these lafter applications is shown in FIG. 5 where CSU distillation program 218 needs all the metrics generated by distillation programs D1′, D2, D3 and D4 to calculate the various CSUs shown at 220. In such a case, each of distillation programs D1′, D2, D3 and D4 has a pointer to the beginning address of CSU distillation program 218. Because some of the CSUs may require metrics that have not been calculated yet where the distillation programs D1′, D2, D3 and D4 are calculated in some arbitrary or programmed order, the CSU distillation program needs a data integrity check to make sure all the metrics needed to calculate the various CSUs have been received. This is done as part of the processing represented by block 257. Block 257 represents the process of following the pointer in the distillation program just finished to a CSU distillation program and plugging all the metrics just calculated into the CSU distillation program formulas and plugging in all the licensing terms from the appropriate provisioning item into the appropriate variables of the appropriate formulas. The pertinent provisioning item is found by following pointers from the usage data buffer to the resource authorization node, to the authorization node to the data entry representing the user and from there to the provisioning item under which said user has taken a license. After plugging in all the metric and license term data, a data integrity check is performed to make sure all the necessary metrics and licensing terms have been received, as represented by steps 257 and 259. If not, processing returns to step 253. If all the necessary data is present, processing goes to step 261 where the CSUs are calculated by evaluating the formulas in the CSU distillation program using the metric data just plugged into the variables thereof.

In alternative embodiments, the usage-measuring server will be programmed to allow the user to which each said CSU distillation or mapping program is dedicated to access the data structure remotely, access the CSU distillation program and alter the formulas therein. In the preferred embodiment however, to prevent fraud by unscrupulous users, the formulas in the CSU distillation programs can only be altered by the licensor under which the user/licensee takes his license, and any attempts to access a distillation program or CSU distillation program by a licensee will be blocked by the security barrier mechanism in said usage-measuring server. In embodiments where the licensor is allowed to alter the formulas in a distillation or CSU distillation program, the licensor my access the data structure remotely by the process in FIGS. 9A and 9B.

In some embodiments, the CSU distillation program is automatically launched after new metric data is stored. In other embodiments, the CSU distillation program is launched automatically on a fixed schedule. In other embodiments, after new metric data is stored, the server sends a message to the pertinent licensor and requests instructions on whether to launch the CSU distillation program(s) to use the metric data.

Overall Process to Gather Usage Data, Convert it to Metric and Allow Access Thereto

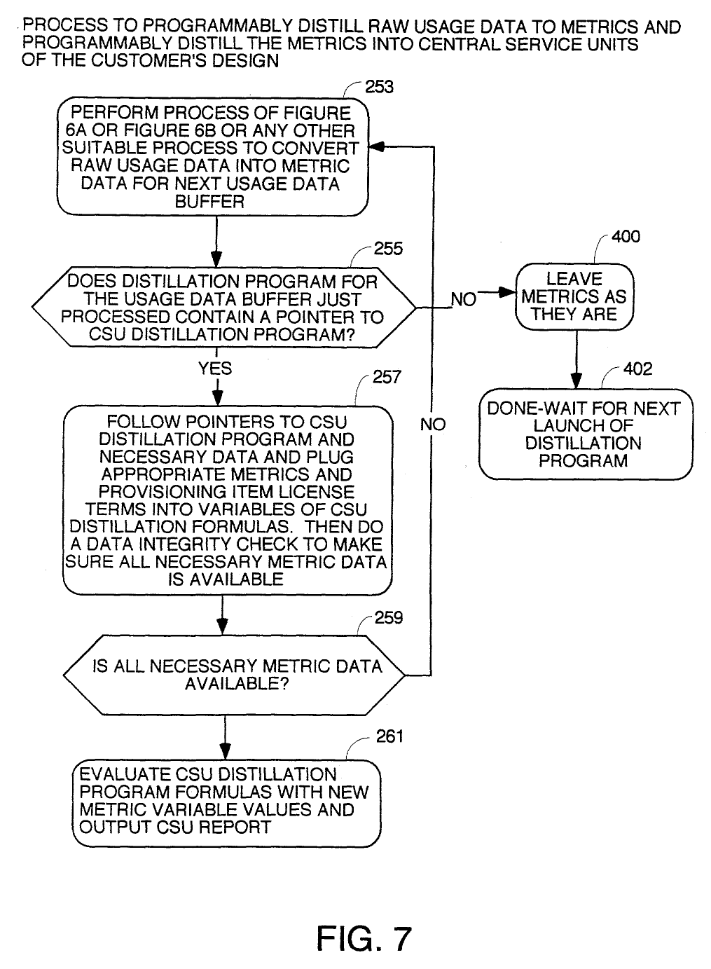

FIG. 8 is a flowchart of the overall process of collecting usage data at the client sites, uploading it to a central server and storing it there and processing said usage data into metric data and allowing access to the raw usage data and metric data. Step 230 represents the process of using a monitoring or agent program installed one one or more computers at the distributed sites of said licensees to measure the usage of resources installed on those computers and licensed to each licensee on a usage-basis. This process is commonly known in the prior art and any prior art process will suffice to do it or the process described in the patent application incorporated by reference herein can be used to do it.

Step 232 represents the process of sending the usage data so gathered regarding use of all resources by all distributed clients to one or more usage measuring servers. Typically, one usage measuring server will suffice, but in massive systems where the amount of data is too large for one server, the data structure can be segregated in any logical way, and multiple servers can be used to store and process different segments of the data structure. The data may be transmitted to the usage measuring server via any data path such as internet, private dedicated WAN, virtual private network, snail mail or courier delivery of electronic media containing the data or any other way of delivering data, or any combination of the above.

Step 234 represents the process of receiving and storing the usage data in segregated buffers. This means that there is in the server data structure a separate buffer for the use of each resource by each licensee, even if the licensee licensed multiple resources in a package or suite license.

Step 236 represents the process of using an appropriate distillation program for each resource associated with each buffer to convert the raw usage data into metrics. The metric data derived from each buffer is then stored in the data structure. The appropriate distillation program can be determined by following the pointers from the buffer to the resource authorization node to the authorization node to the provisioning item under which the license was granted to the resource corresponding to the buffer. In alternative embodiments, each raw usage buffer will have a pointer to the proper distillation program to use to distill it. In the case certain distributors write their own distillation programs, a look up table can be maintained by the server and when data from a particular client regarding a particular resource comes in, the look up table can be consulted to determine a pointer to the proper distillation program.

Step 238 represents the process of allowing only users authorized to know the details of usage of particular resources by particular licensees to have access to the raw usage data and/or metric data. Generally, this blocking of unauthorized access can be accomplished in any manner. Typically, authentication of the user by use of a log-in name and password will be used to establish the identity of the user. Once the user's identity is established, the server consults configuration data that defines which metrics and/or raw usage data or metrics alone or CSU units alone or in combination with metrics to which that user is allowed to have access. Any form of security barriers such as consulting lookup tables of authorized users to have access to particular data using their login authentication data as a search key may be used.

Step 238 also represents the process of using the server and metric data to prepare automated reports and/or invoices that represent the amount of usage of the licensed resources by licensees. This is done by the processes of FIGS. 6A or 6B to generate metrics or by the process of FIG. 7 to generate CSUs.

Process to Build Usage Measuring Server Data Structure and Restrict Access thereto

Referring to FIGS. 9A and 9B, there is shown a flowchart of the general process to build the data structure of the usage measuring server and provided restricted access to data stored therein. Although the flowchart indicates a particular order of steps, that order is not critical and any order and programming structure that allows users to log in, authenticate themselves, declare resources and clients and the attributes and relationships thereof and to have restricted access to metric, raw usage data and/or CSU data will suffice. The process starts with block 264 where the server 20 in FIG. 1 receives a log in communication from a vendor's browser 24 or a communication program running on a computer of the vendor and transmitted over the internet, some other form of WAN or via a direct dial up connection or by any other data path. The log in communication contains the user's user name and password. Step 266 represents the process of using the user name and password to authenticate the user's identity. Step 268 represents the branching to step 270 to send an access denied message if the user or vendor is not authorized to use the system. Step 272 represents the process of sending an inquiry to the user requesting him to identify which client(s) and/or which resource(s) he wants to view, modify or download. Step 272 also inquires of the user which metric, raw usage and/or CSU data are of interest to the user for viewing or download.

Step 274 represents the process of receiving messages from the user/vendor which identifies which client(s) and/or resource(s) she wants to view, download or modify and, if metric, raw usage and/or CSU data is of interest, which data the user wants to view or download. No modifications to metric, usage or CSU data are allowed.

In step 276, the server 20 uses the identity of the data of interest to search configuration data that defines which client and resource data to which the user has access, and, if access to metric, usage or CSU data is requested, which if any metric, raw usage and/or CSU data to which the user has access. Step 278 is the branching which depends upon the results of this inquiry. If the configuration data indicates the user does not have access to the data he requested, step 280 is performed to send the user a message indicating access is denied. . In some embodiments, steps 276 and 278 are omitted. If the user does have access to the requested data, step 282 is performed to send the requested data to the user to view or download.

Step 284 represents the process of sending a message to the user (vendor or licensor) inquiring whether the user has any new resources and/or clients and/or new provisioning items or provisioning lists to declare or any new distillation programs or CSU distillation programs to enter into the data structure or whether the vendor/licensor has any distillation or CSU distillation programs he would like to modify. . If not, test 286 causes branching to step 288 where the session is terminated. If the user/vendor indicate he does have new resources and/or clients and/or provisioning items or lists to declare etc., step 290 is performed to request transmission of the pertinent data and transmit any data needed by the licensor to view or modify the existing data structure entries to which the licensor has access. The licensor then sends new data that defines the new clients and/or resources and/or provisioning items/lists and the attributes thereof including any relationships with other entities or resources represented by other data in the data structure and any modified or new distillation programs and/or CSU distillation programs. Step 290 also represents the process of receiving any data transmitted by the user in response to the request.

In step 292, the server uses the transmitted data to create new data entries/distillation programs in the data structure. The new data entries memorialize the new client(s) and/or resource(s) and/or provisioning items/lists identified in the data. The server also sets up the pointers which establish the relationships between the new data entries and other data in the data structure such as distillation programs, provisioning lists, provisioning items, authorization nodes, resource authorization nodes and CSU mapping programs. The server also records the new distillation and/or CSU distillation program(s) and establishes pointers in the proper data structure to point to these programs. Where these pointers are written depends upon the embodiment for CSU distillation being implemented, as described above.

Licensing as a Suite Resources Provided from Multiple Vendors

It is useful to be able to do usage-based licensing of one or more resources from one or more vendors as a suite. This type licensing is not believed to be currently available. Most of the claims and the following discussion use the term suite to refer to two or more resources made available for sale or usage-based licensing by one or more vendors. Usage-based licensing or sale of a suite of two or more resources from two or more different vendors is believed to be novel, but it may also be novel to do usage-based licensing of conventional suites of two or more resources available from the same vendor. Some of the claims therefore use the term suite to refer to one or more resources available for sale or usage-based licensing from one or more vendors using a usage-measuring server data structure to support the distribution of the resources in the suite.

Provisioning item PI 3 at 408 in FIG. 5 is an example of how the data structure can be used to license a plurality of different resources from two or more vendors as a suite. PI 3 was created by vendor/distributor 127 to make available under a single licensing provision all the resources to which the entity 127 has rights. In the particular distribution system modelled in FIG. 5, entity 127 has the right under PI 1 to distribute R1 and R2 and has rights under PI 2 to distribute R3. To that end, provisioning item PI 3 at 408 is a data structure which contains data recording the licensing terms as well as pointers to at least the resources available for license under that provisioning item (represented by links 416, 420, 418 and 414). PI 3 also optionally has links to provisioning items PI 1 and PI 2. Entity 127 also has authored R4 and is making R4 available as part of a suite of resources made available for licensing under the terms of PI 3. PI 3 at 408 shows a link 410 to PI 1 at 304 to make R1 and R2 available and a link 412 to PI 2 at 306 to make R3 available. The link 414 makes R4 available under PI 3. Entity 127 also makes R4 available as a separate unbundled resource under the licensing terms recorded in the PI 4 data item at 308.

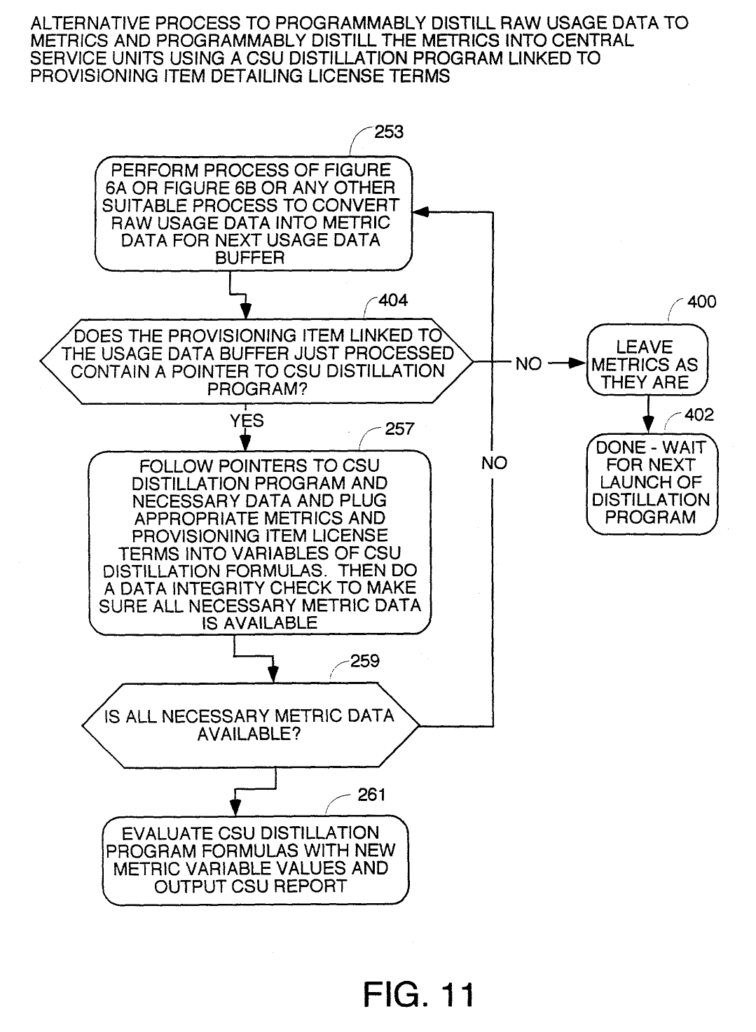

FIG. 13 is a flowchart of the process to create the data structure to support a suite license and to use that data structure to implement suite licensing of multiple resources from different vendors. Step 440 represents the process of creating each provisioning item that stores data that records the license terms of the suite license and which points to the individual resources from the various vendors which comprise the suite. This can be done by the licensor using a local terminal or via a remote log-in over the internet, another WAN or direct dial up. The licensor usually does this by creating a table that has entries that record the license terms and has pointers to the data entries representing the resources in the suite. In some embodiments, the licensor also writes data that will control the formulas of a CSU distillation program into the provisioning item table or programs the formulas in a CSU distillation spreadsheet that is linked to or part of the provisioning item. In other embodiments, the CSU distillation program may be omitted or pointed to by data entries in the usage data buffers or the distillation programs for each resource in the suite.

Even though multiple resources are licensed as a suite, the agent programs at the client computers still collect usage data on a per resource basis. Thus, separate usage buffers must be created in the server data structure to collect the usage data for each resource. These separate usage buffers are shown at 200, 206, 208 and 210, and store usage data from agent programs for resources R1 through R4, respectively. However, the usage data buffers 200 through 210 must all be linked back to the single provisioning item that defines the license terms for the suite. This is done through authorization node 422 and separate resource authorization nodes 424, 426, 428 and 430. The authorization node 422 is created when a customer such as customer 300 takes a license under the terms of provisioning item PI 3, and a pointer 432 is stored in the authorization node data structure which points to the provisioning item 408 which records the license terms under which the customer took a license.

This process of creating the authorization node is represented by step 442 in FIG. 13. The licensor typically logs in through a web interface (but it could be done through a local terminal) and clicks on various links to perform the functions of establishing an authorization node that at least identifies the licensee and setting a pointer therein that points to the provisioning item under which the license was taken. The various menu items and links mask an application programmatic interface with various function calls linked to the menu items and links and which establish the data structure for the provisioning item and record in it the appropriate pointers to the resources and any data or formulas that define a CSU distillation program, if used.

Each authorization node represents an existing license and is created in this way by the vendor or other licensor who created the license when the license deal is completed. In the preferred embodiment, the licensor logs in and creates the authorization node and sets the pointer therein to point to the provisioning item which records the license's terms. After this is accomplished, in the preferred embodiment, the usage measuring server automatically creates the necessary resource authorization nodes based upon the resources pointed to by the provisioning item pointed to by the authorization node and automatically allocates memory space for a usage buffer for each resource authorization node. In alternative embodiments, the licensor also creates the resource authorization nodes and usage buffers manually by invoking function calls in a web interface or an application programmatic interface the licensor can access when he logs in and authenticates. Step 444 in FIG. 13 represents both this automatic or manual creation of the resource authorization nodes and usage buffers. Step 444 ends the process of creating the necessary data structure, and step 446 represents the beginning of a subprocess to use the data structure so created to implement suite-based, usage-based licensing of multiple resources from different vendors.

Each authorization node is linked to one or more separate resource authorization nodes by a pointer. Each resource authorization node represents one resource licensed on a usage-basis under the license. Each resource authorization node is linked to a usage buffer which records the usage data for the corresponding resource. The resource authorization nodes and usage buffers are created with the authorization node either when the license is taken or sometime thereafter when they are needed such as when the first usage data arrives. In the case of authorization node 422, resource authorization nodes 424 through 430 are created for resources R1 through R4, respectively. The linkage between the authorization node and the provisioning item is represented by pointer, and the linkage between the authorization node 422 and the individual resource authorization nodes is represented by line 434 which is intended to represent individual pointers to each resource authorization node 424 through 430.

Each resource authorization node is a table which has an entry called a pointer or link in the claims which points to its parent authorization node with additional pointer entries to each resource authorization node corresponding to a resource licensed under the suite Each authorization node such as 422 contains a pointer (432) to the provisioning item (408) that points to the resources (R1 through R4) for which resource authorization nodes linked to that authorization node have been created and for which usage data is to be collected in the usage data buffers. Each resource authorization node's usage buffer functions to store data on the usage of one resource licensed under the suite license by the one licensed user.

The foregoing describes how the data structure is created for suite licensing. This data structure is used for suite licensing by storing raw usage data for each resource by each user in the appropriate usage buffer (step 446 in FIG. 13), converting that usage data to metrics (step 448, FIG. 13) and, in some cases where the user does not want individual metrics for each resource in the suite, converting those metrics to CSU units that make sense to this user such as a total dollar figure for the month's usage (step 450, FIG. 13).

Process for Clients to Shop All Available Licensing Deals from Different Vendors for the Same Resource from one Source

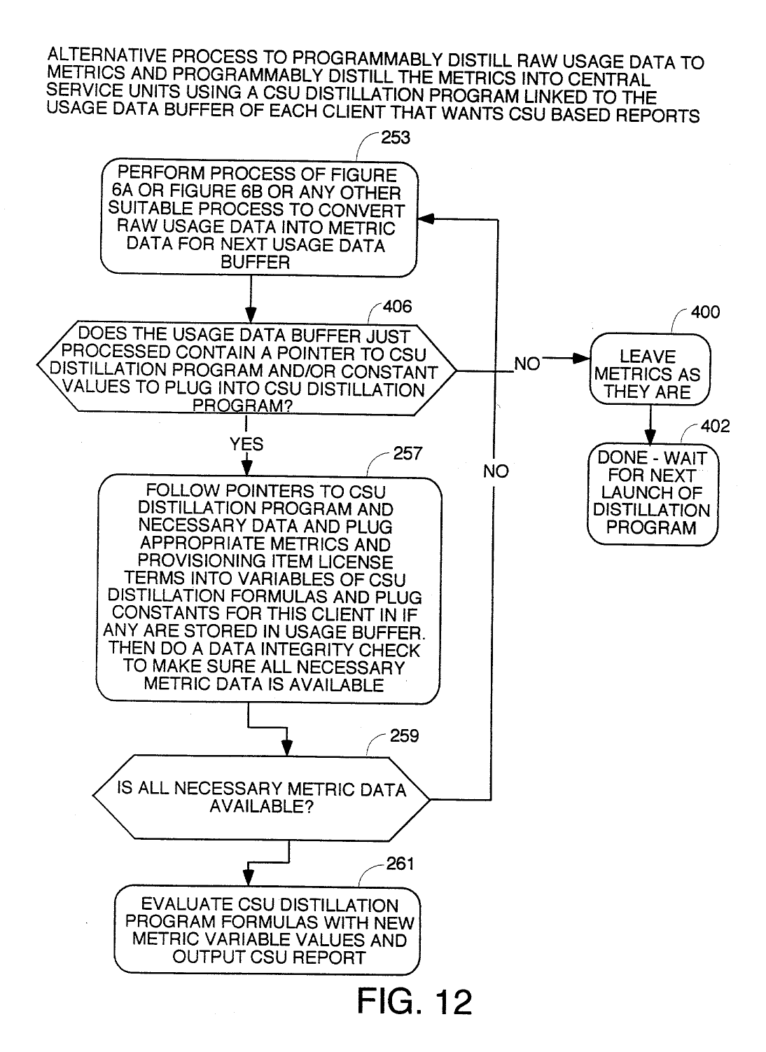

The data structure of the usage measuring server makes one stop shopping for a license deal on a resource easy. The usage measuring server 20 in FIG. 1 has a web interface symbolized by crosshatched box 51 in FIG. 2. FIG. 14 is a flowchart of the process that is implemented with a user wants to shop all available license deals on a particular resource regardless of which vendor or distributor makes the resource available.

The process starts with step 470 wherein a customer logs into the usage measuring server and gives her user name and password. In step 472, the server 20 uses the user name and password and authenticates the user. The server 20 then sends HTML or other types of messages to the user from the web interface 51 which displays a web interface on the user's computer. That interface has menu options and/or links the user can select to issue commands to the server. These commands or selections cause messages to be sent to the interface 51 and invoke function calls of an application programmatic interface which links the interface 51 to a library of programs that can be executed to carry out the selected command or function. The user then selects a command to shop all available deals. In some embodiments, that command may have a text box associated with it to name the resource to shop, and that data will be sent to the server along with the command to shop all deals. However, in the embodiment of FIG. 14, to eliminate the difficulties of user's misspelling resource names or using words that are not used in the description of the resource in the server data structure, another approach is used. That approach is symbolized by step 474. There, the server 20 responds to the shop all deals command by transmitting messages to the customer that lists all resources in the server 20 data structure which are available for licensing. This data causes a list of resources to be displayed on the customer computer.

In step 476, the user selects a resource to shop and this causes a message to that effect to be sent back to the server 20. In step 478, the server receives this message and accesses the data entry for the resource identified by the customer. In this particular embodiment which enables onestop shopping, each resource data entry such as 417 for R1 in FIG. 5 also contains pointer data to point to all the provisioning items which point to it. To implement this embodiment, when a provisioning item data entry is created by a vendor or distirbutor and pointers are set up to the resources licensed under that provisioning item, the server 20 is programmed to automatically access each such resource data entry when a pointer is set up to point to it and to add a reverse direction pointer which points back to the provisioning item for which the pointer was just set up.

In step 480, after having received the resource selection and accessed the resource data entry, the server follows pointers in the resource data entry back to all the provisioning items which point to that resource. Thus, all available license deals on that resource, regardless of which vendor or distributor makes the license deal available, will be found in step 480.

In step 482, the server reads the license term data in each provisioning item and sends messages to the customer which causes displays on the customer computer. These displays list each available license and its terms. The vendor or distributor name may also be listed, but that is not necessarily required in all embodiments. That is the end of the one stop shopping process. An extension of this process is described in steps 484 and 486 to allow the customer to actually pick a license and to set up the necessary data entries in the server data structure to implement that license.

In step 484, the customer selects a license from the displayed list, and this causes a message to be sent back to the server.

In optional step 486, the server receives the message and automatically sets up an authorization node linked to the provisioning item that records the terms of the license and is linked to a data entry that represents the customer that took the license. In some embodiments, the server 20 can also automatically follow pointers from the provisioning item to all the resource data entries and set up a separate resource authorization node for each resouce and an associated usage data buffer to record usage by that customer of that resource.

Multiple Authorization Nodes for the Same Customer and the Same Provisioning Item

Referring to FIG. 5 again, note that there are two authorization nodes 422 and 423 for customer 300, both linked to PI 3 at 408. Authorization node 422 contains information pertinent to customer 300's use of resources at its Dallas office, which authorization node contains information pertinent to customer 300's use of the resources at its New York office. These two authorization nodes contain information needed to track usage of the resources at the Dallas and New York locations. For example, the authorization nodes may contain IP addresses of the licensing servers at those locations so that messages may be sent there telling the agents what types of usage data to collect, etc. Basically, the authorization nodes such as 422 and 423 store whatever information is needed to manage the process of collecting usage data from each location, store it in a properly segregated fashion and use it to generate metrics and/or CSUs for billing the customer or reporting usage in each location if necessary or overall if so desired. This information is collectively referred to as information needed to manage the process of collecting usage data in the claims.

Temporal Treatment of Usage Data

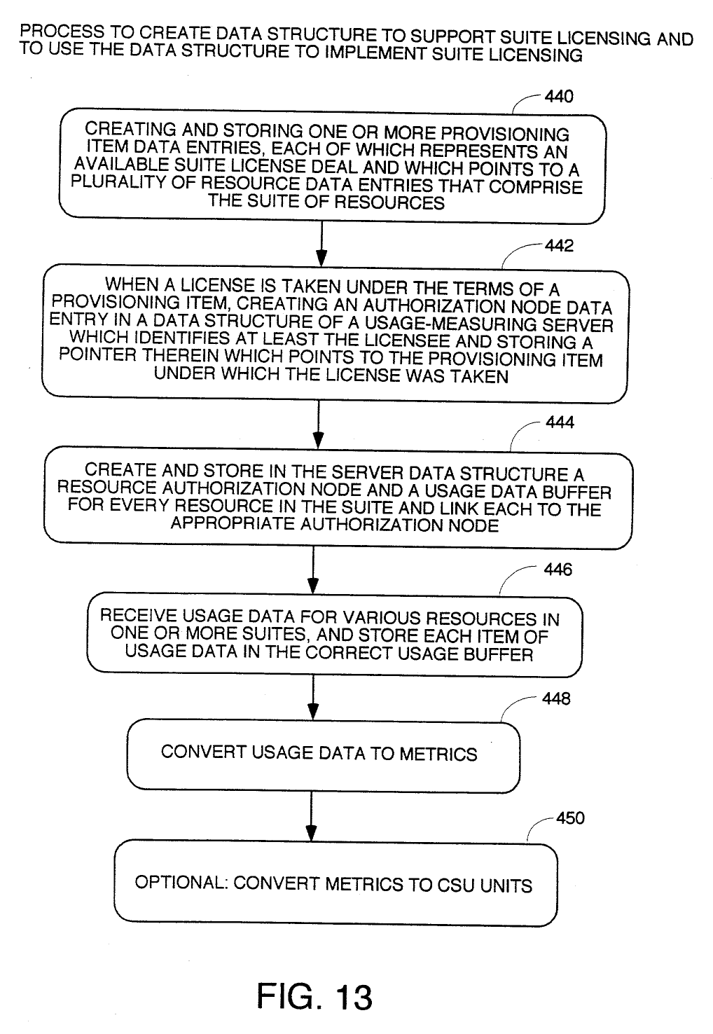

FIG. 15 is a diagram illustrating how usage data may be stored in the order in which it arrived as well as by the day of the week it occurred. In this example, a resource 500 offered by organization 502 is licensed under the terms of provisioning item 504 by user 506. An authorization node 508 is created which is linked to a resource authorization node 510. The resource authorization node is linked to or contains a usage data buffer 512 which is segregated into multiple sections or comprises multiple FIFO buffers, one for each segment of time for which there is an interest in generating metrics. In the particular example chosen, the buffer 512 is segmented by day of the week on which the usage occurred. As such, it has separate sections 514, 516 and 518 for recording usage which occurred on Monday, Tuesday and Wednesday, etc. The day of usage is represented by sections along the X axis 520 which the time that the data actually arrived at the usage-measuring server is recorded along the Y axis 522. Thus, for example, resource 500 was used three separate times by user 506 on Monday, as represented by user data nuggets 524, 526 and 528. On Tuesday, it was used twice, at two different times represented by nuggets 530

By segregating the usage data into logical “time compartments” of any length, metrics may be calculated for any reporting interval equal to the duration of a time compartment. The time compartments may be any length such as every hour, every minute, every day, every week, month or year, etc. The segregation of the usage data into time compartments may also be accomplished in any way such as separate areas of memory, separate physical FIFOs, or tagging each usage data nugget with the day, hour, minute, month, week etc. when the usage occurred and, optionally, tagging each nugget with the time it arrived at server 20. Then, all the usage data nuggets can be sorted into the time compartments in which they occurred or organized into one linked list for each time compartment with only the nuggets of usage that occurred during a particular time compartment on the linked list for that time compartment.

By organizing the usage data into time compartments, the distillation program for the resource which was used can be run multiple times with the input data for each run restricted to only the usage data for a particular time compartment. This generates a set of metrics for each time compartment. This is shown in FIG. 15 as distillation program D1 at 534 executing once on the usage data nuggets in time compartment 514, as represented by arrow 536 to generate the metrics M1, M2, M3, etc. in a corresponding time compartment 538 for metrics. Metric M1 may represent CPU hours used and M2 might represent the number of pages of text processed or drawing made. Likewise, distillation program 534 is executed again, as symbolized by arrow 538, on the usage data nuggets in compartment 516 to generate the metrics for Tuesday in time compartment 540 of metrics buffer 542. In the claims, the time compartments are referred to as time segments.

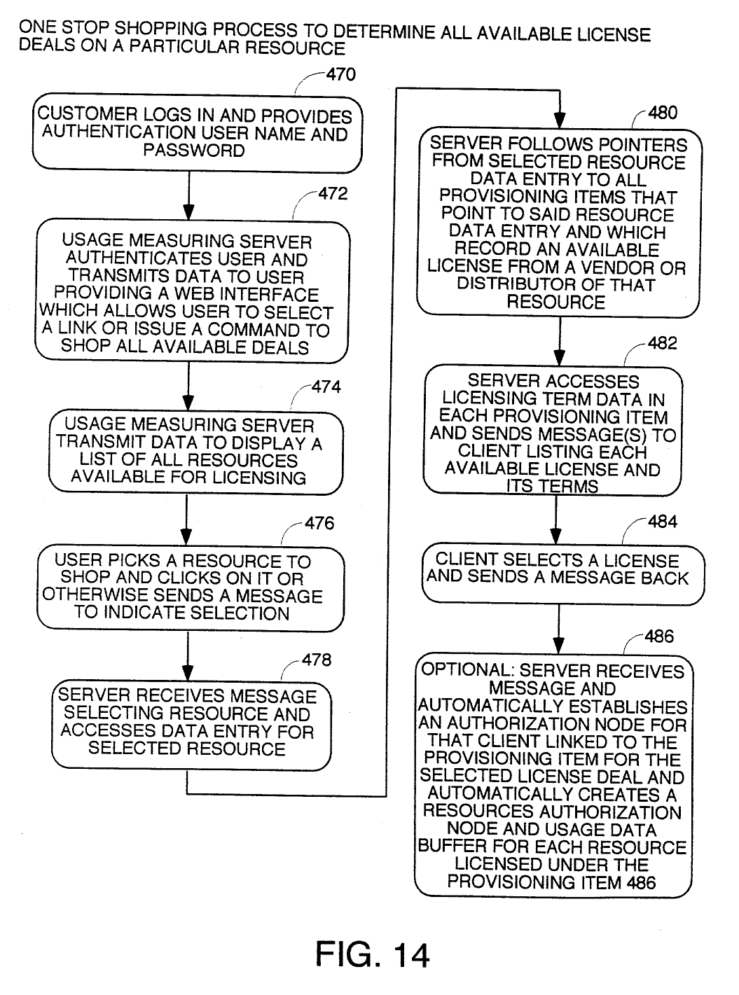

FIG. 16 is a flowchart of the process to implement this time segmentation of usage data and generate metrics for each segment. Step 544 represents the process carried out by each agent program of collecting usage data of each resource along with the time and date of the usage and getting that data in any way to the usage measuring server 20. Typically this is done by sending the data to the licensing server on the LAN of the client's facility where the usage occurred and storing it there and then periodically sending the usage data to usage measuring server 20. The language “directly or indirectly” is a teaching that the usage data can be sent to the usage measuring server through an intermediary local server or buffer, as just discussed, or by having the agent establish a session with the usage measuring server directly and uploading the data.

Step 546 is the process of the usage measuring server receiving the usage data and storing it in the appropriate time compartment of the appropriate buffer assigned to store usage data of that particular resource by that particular client. This can be done by any of the methods discussed above such as by use of separate address spaces or separate address segments of the usage data buffer for each time compartment, or by use of a separate linked list for each time compartment, or by use of physically separate FIFOs for each time compartment, etc. Any way of separating the data logically will suffice to practice this particular teaching.

Step 548 represents the process of the usage measuring server determining in any way that it is time to run the distillation program linked to the resource for which the usage data was collected. This can be done by checking a schedule that is set to cause the distillation program for a particular resource to run once at the end of each time compartment. It can also be done by checking configuration data that sets time intervals between runs or in any other manner.

Step 550 represents the process carried out by the usage measuring server of launching the distillation program for the resource for which usage data has been collected and partitioned and assigning the distillation program to process the usage data of a particular time segment in a particular user data buffer. This is done by the following pointers from the usage data buffer to be processed up through the resource allocation node, the allocation node, and the provisioning item to the resource node and from the resource node to the appropriate distillation program and then giving the distillation program a pointer to the appropriate buffer, FIFO or linked list storing the usage data for the time segment of interest.

In step 552, the distillation program retrieves the usage data for the appropriate time segment and, retrieves the license terms if necessary, plugs the retrieved data into the appropriate variables of the appropriate formulas and processes the data into metrics. These metrics are then stored by step 554 in the appropriate memory dedicated to storing metrics for the time segment which the distillation program just processed.

In some embodiments, configuration data will define a second larger time segment such as a month or a quarter year. A CSU distillation program will be launched at whatever scheduled intervals are defined by the configuration data such that one CSU program execution will occur per each second larger time segement. The CSU program will be directed to access the metric data for all the time segments within the second larger time segment it is processing and convert that metric data into CSU units that summarize the amount of usage or amounts owed etc. for the second larger time segment.

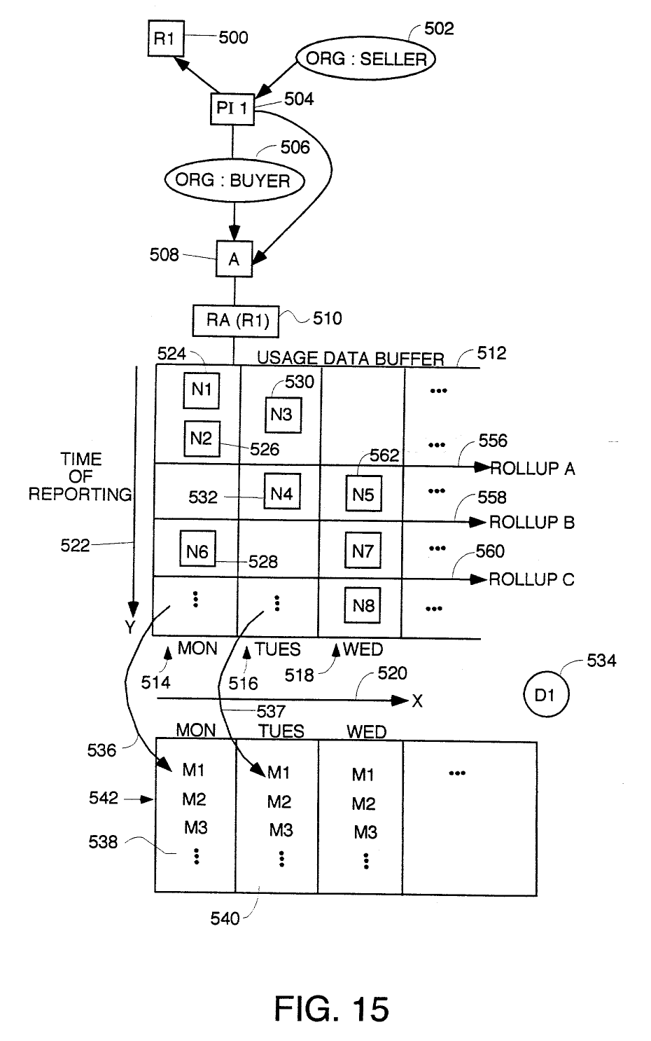

The process represented by FIG. 16 represents the steps of one “rollup”, i.e., processing, of usage data into metric data. In FIG. 15, three separate rollups per day are shown as rollups A, B and C at different times 556, 558 and 560. FIG. 17 represents the hypothetical numerical values of metrics M1, M2 and M3 for Monday, Tuesday and Wednesday after rollup A on Tuesday using the usage data of FIG. 15. M1 is CPU time, M2 is number of documents processed and M3 is number of pages processed.

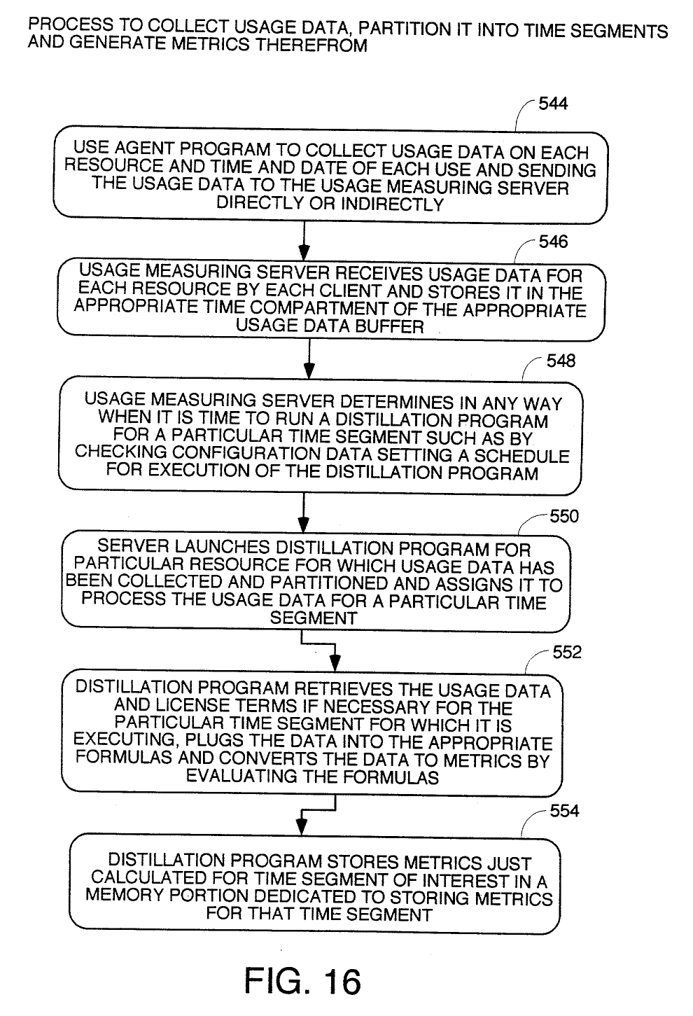

FIG. 18 represents the numerical values of metrics M1, M2 and M3 after rollup B on Wednesday using the raw usage data of FIG. 15 for one alternative embodiment which limits the input to each rollup to only usage data for uses after the last rollup. Note that as of time 558 of rollup B on Wednesday, new usage data nugget 532 had been received for Tuesday and a nugget 562 had been received for use on Wednesday. Rollup B restates metrics M1, M2 and M3 for Tuesday without including the usage data that arrived for Tuesday usage before rollup A at 556. Thus the values of M1, M2 and M3 for Tuesday after rollup B are different and happen to be lower than the same metrics for rollup A for Tuesday. This is because the M1, M2 and M3 values for Tuesday generated by rollup B do not summarize the usage data from both nuggets 530 and 532. They only summarize the usage in nugget 532.

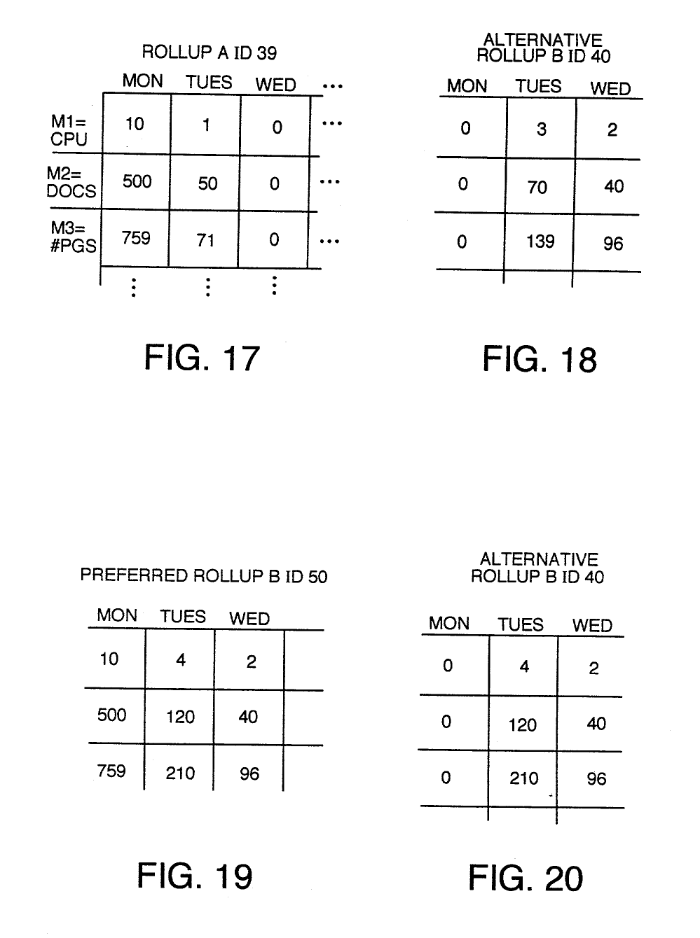

In the preferred embodiment however, each successive rollup during any particular time segment restates the metrics for that time period taking into account all the usage data for uses during that time segment before the time of the rollup. This is represented by FIG. 19. FIG. 19 shows that for Tuesday, metrics M1, M2 and M3 are the summation of the same metrics for Tuesday from FIGS. 17 and 18 indicating rollup B at 558 summarized usage nuggets 530 and 532 for Tuesday in FIG. 15. Since no new data for Monday had been received for Monday, M1 through M3 on Monday in FIG. 19 are the same as M1 through M3 on FIG. 17.

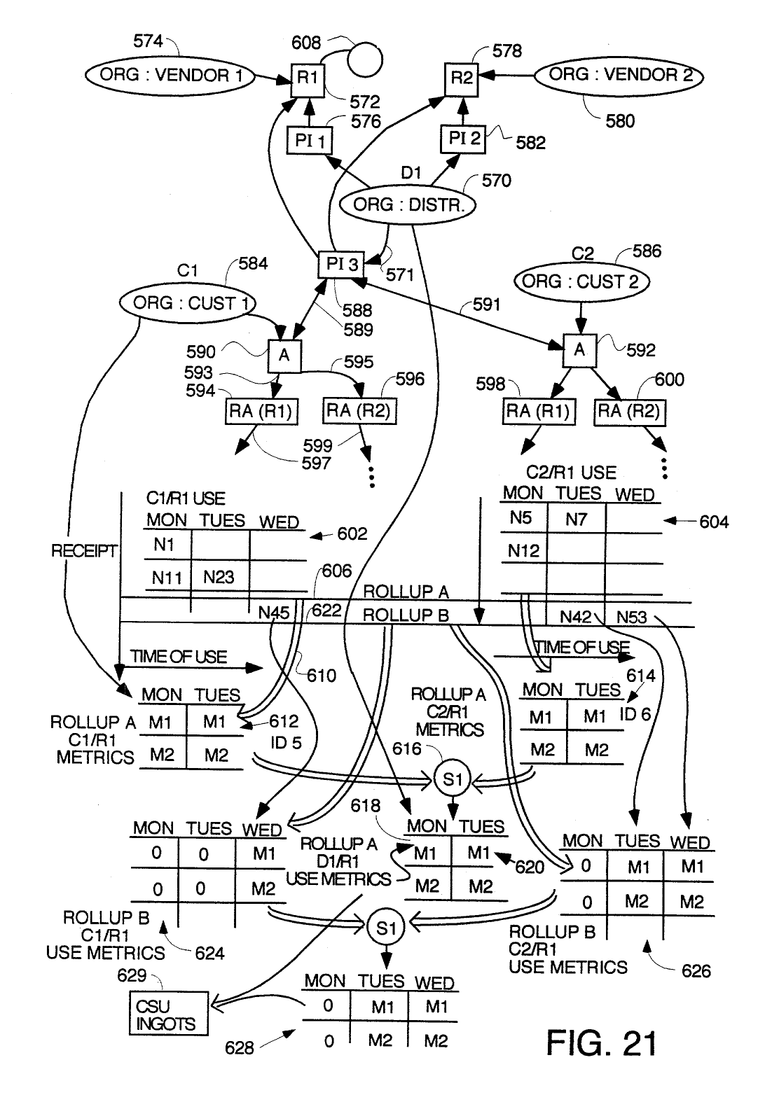

In another alternative embodiment, represented by FIG. 20, each successive rollup will restate the metrics for a time segment using all the usage data for that time segment that occurred before the time of rollup, but if no new usage data has been stored for a particular time segment for usage since the time of the last rollup, no restatement of the metrics for that day will occur. For example, in FIG. 20, rollup B at 558 in FIG. 15 will restate the metrics for Tuesday because new nugget 532 arrived after the time of rollup A at 556. However, Monday will be ignored since no new nuggets were received for Monday after the time of rollup A at 556. Wednesday will be summarized because nugget 562 arrived after rollup A and before rollup B.

Some clients are interested in generating metrics summarizing their use for every day or every week etc. but they want to also be able to view all the latest metrics so generated for some larger period. For example, suppose a customer wants to generate metrics for every day of the week with three rollups per day and to view the lastest metrics for each day at the end of every week. Each set of metrics generated by execution of the distillation program is called an ingot and has its own ID number, and these ID numbers rise sequentially with each rollup. With the embodiment of FIG. 19, to view the latest metrics for each day of the week at the end of the week would require only accessing the last ingot of metrics from the last rollup of the last day of the week as this rollup would restate the metrics for every day of the week using all the usage data that occurred on each day of the week before the time of execution of the rollup. With the embodiment of FIG. 18 however, the three rollup ingots for each day would have to be summed to create a report with the latest metrics for each day. However, for the embodiment of FIG. 20, the weekend summarization would have to do some comparison. In this embodiment, the final weekly summary would use the metrics for Monday from the ingot having the highest ID number that had metrics for Monday in it, and likewise for Tuesday and Wednesday. The final report would be a collage of these strings of metrics so extracted.

In still another embodiment, it may be of interest for a vendor or user to have flexibility as to what period to cover by the summary report or which method of rollup to use or both. In this embodiment, configuration data can be programmed to control the period covered by each summary report and other configuration data can be programmed to control which rollup method is used.

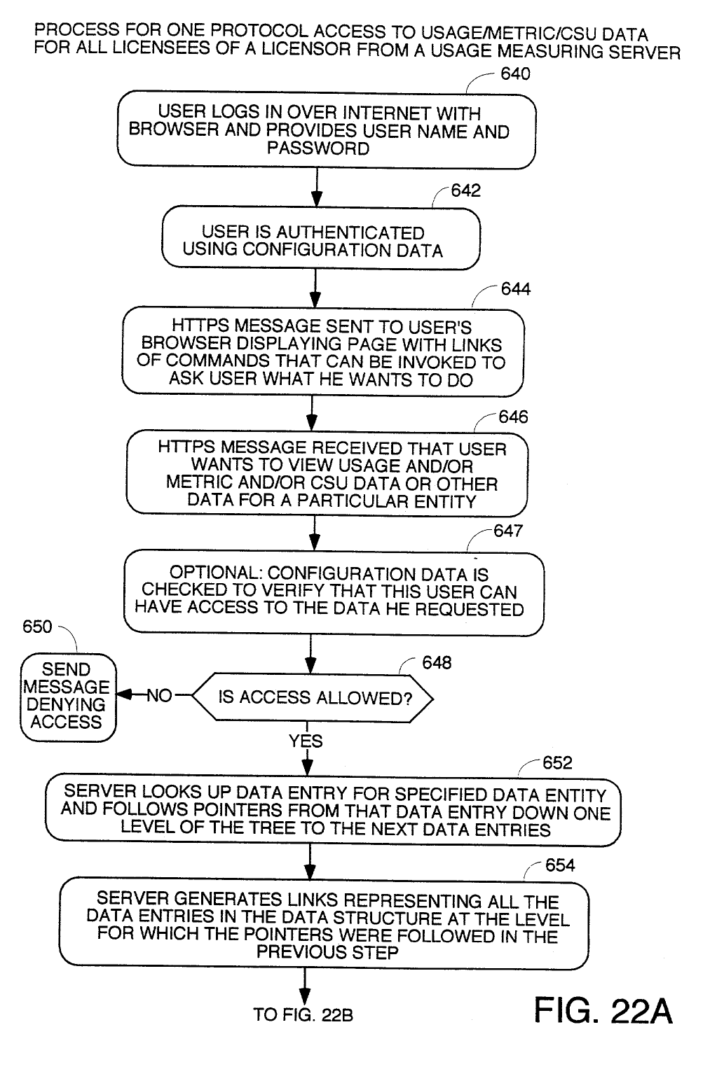

Referring to FIG. 21, there is shown a diagram of a data structure in usage measuring server 20 which allows multilevel temporal summarization of usage data for both customers of a distributor as well as the distributor itself. In the illustrated data structure, a distributor D1 570 has licenses to distribute resource R1 572 provided by vendor 574 under terms of provisioning item 576 as well as resource R2 578 provided by vendor 580 under terms of provisioning item 582. Distributor 570 licenses both R1 and R2 as a suite to customer C1 584 and customer C2 586 under the license terms of provisioning item 588. Authorization nodes 590 and 592 memorialize these two licenses and spawn resource authorization node 594 for C1's use of R1 and 596 for C1's use of R2. Likewise, authorization node 592 spawns resource authorization nodes 598 for C2's use of R1 and 600 for C2's use of R2. C1's use of R1 is collected in usage buffer 602 segmented by day of the week. A similar buffer, not shown, is used to collect usage data for C1 use of R2. C2's use of R1 is collected in buffer 604, and use of R2 is collected in a similar buffer not shown.

A rollup A of C1's R1 usage data in buffer 602 is performed at time 606 using distillation program 608, as represented by arrow 610 which results in ingot ID5 at 612 of metrics M1 and M2 for C1's use of R1 on Monday and Tuesday. The same rollup of C2's R1 usage data results in ingot ID6 at 614 with metrics M1 and M2 for each use on Monday and Tuesday. The same rollup also results in metric ingots for R2 usage by C1 and C2 although the formulas in the distillation program may combine R1 and R2 usage by C1 into one set of metrics and likewise for C2. For purposes of billing customers C1 and C2 for their usage, distributor 570 may use the ingots at 612 and 614. However, for convenience in paying its license fees to vendors 574 and 580, distributor 570 also needs metric data of the combined usage of R1 by C1 and C2 and the combined usage of R2 by C1 and C2.

For distributor 570, the metrics in ingots 612 and 614 can be combined in any way that makes sense or is required by the licenses with vendors 574 and 580, but usually they are just summed. This process of combination of metrics is carried out by the usage measuring server 20 under control of program S1 at 616. This program can be as simple as just adding the R1 M1 usage metrics for Monday from ingots 612 and 614 together and writing the sum as metric M1 at 618 in ingot 620 for distributor 570 and likewise for M2 and repeating the process for M1 and M2 for Tuesday.

Now suppose, nugget N45 arrives for C1 use of R1 after rollup A, and nuggets N42 and N53 arrive for C2 use of R1 after rollup A at time 606. Another rollup B at time 622 is then performed to process this new data and generate new metric ingots 624 and 626. In this particular embodiment, only the new data is processed and any time compartment with no new use data has its metrics set to zero. However, other embodiments could restate the metrics for every time compartment that has new data to include both the new and old data in the calculation and simply copy the old metric data into the new ingot for any time compartment that did not have any new data. Program S1 is then invoked again to combine the metrics of ingots 624 and 626 to generate a new ingot 628 of metrics for distributor 570 representing distillation of just the new usage data (or a restatement of the time compartment combining both new and old data) for each time compartment that had new usage data since rollup A.

In the preferred embodiment, the metrics for a distributor which has multiple licensees and subvendors are generated by creating a union set of the raw usage data of each user of a particular resource, and then inputting that union set to the distillation program linked to the data entitry representing that resource. Then this process is repeated for every other resource licensed. This process can also be performed in alternative embodiments using a special distillation program D1′ which is defined to map usage data to metrics only for a higher level mapping when a union set of usage data of a particular resource collected from the usage buffers of multiple client users of a licensor/distributor of the resource and the usage buffers of subdistributors and client users of the subdistributors.

Decoupling of Vendors/distribtors from Complexity of Collecting Metric Data from Users All Over the World

FIG. 21 illustrates how the data structure and usage server provides a means by which distributor 570 or vendors 574 and 580 or others in similar positions may be decoupled from the complexities of collecting usage data from the computer systems of users all over the world. If the usage measuring server 20 and its data structure did not exist, a vendor who is licensing its resources on a usage basis would have to know the URL or dial up telephone numbers of servers on client LANs or client computers all over the world and be able to implement the proper protocols to communicate through all those diverse LANs and client computer protocol stacks to the agent programs that collect the usage data. This is a massively difficult task, and even if it could be done once successfully, changes in addresses, protocols, etc. over time would cause the system to fail of its essential purpose.

However, the existence of the usage measuring server 20 and its data structure changes all that. This is because collecting all the usage and metric data in one place has the effect of decoupling the user from the need to know all the addresses and protocols needed to communicate with every usage-based licensee throughout the world. It only necessary for the user to have a computer with a browser and know the URL of the usage measuring server. That single URL and a TCP/IP protocol stack and browser in the user's computer are all that are needed besides a registered user name and password to access all the usage data and metric data of all licensees at a single location. This is done using the process of FIGS. 9A and 9B wherein the user logs in and authenticates and then specifies the usage data and/or metrics and/or CSU data she wants to view in step 274. If configuration data indicates that this particular user has access to the requested data, then the usage measuring server retrieves the requested data in step 282 and sends it to the user. Step 282 consists of first finding the data entry in the data structure which corresponds to the user whose usage/metric/CSU data is to be viewed. Then, pointers from that data entry to the authorization node(s) representing licenses that user has or has granted are followed. Then pointers from those authorization nodes to the resource authorization nodes are followed to find the usage data for each licensed resource. Then, pointers from the resource authorization nodes or usage data buffers are followed to the metric data ingots are followed. Finally, if necessary, pointers from the usage data ingots to the CSU data are followed. Thus, for example, if distributor 570 has 100 licensees under provisioning item 588, pointer 571 can be followed from data entry 570 to provisioning item 588. From there, pointers 589 and 591 may be followed to the first two of the licensees authorization nodes 590 and 592 and other pointers not shown can be followed to the authorization nodes of the other 98 licensees or subdistributors and their licensees and so on ad infinitum. From authorization node 90, pointers 593 and 595 may be followed to resource authorization nodes 594 and 596. From there, pointers 597 and 599 may be followed to user data buffer 602 for R1 and a similar user data buffer for R2 which is not shown. Likewise for authorization node 592 for licensee 586. Although not shown in FIG. 21, there are also pointers from resource authorization nodes 594, 596, 598 and 600 to the metric ingots 612 and 614 etc. for all licensee authorization nodes and resource authorization nodes and all such metric ingots. Likewise, there is a pointer from every metric ingot to the combined metric ingots of higher level licensees such as ingots 620 and 628, and, in the preferred embodiment, there are pointers from every metric ingot to any CSU ingots generated therefrom such as CSU ingot 629 generated by a CSU distillation program not shown from metric ingots 620 and 628. In an alternative embodiment, all data at all levels of the tree downward from the data entry representing the entity selected by the user is collected and sent over the internet to the user in one or more messages for display by the user's browser. Preferably these messages are sent in a secure protocol such as HTTPS.

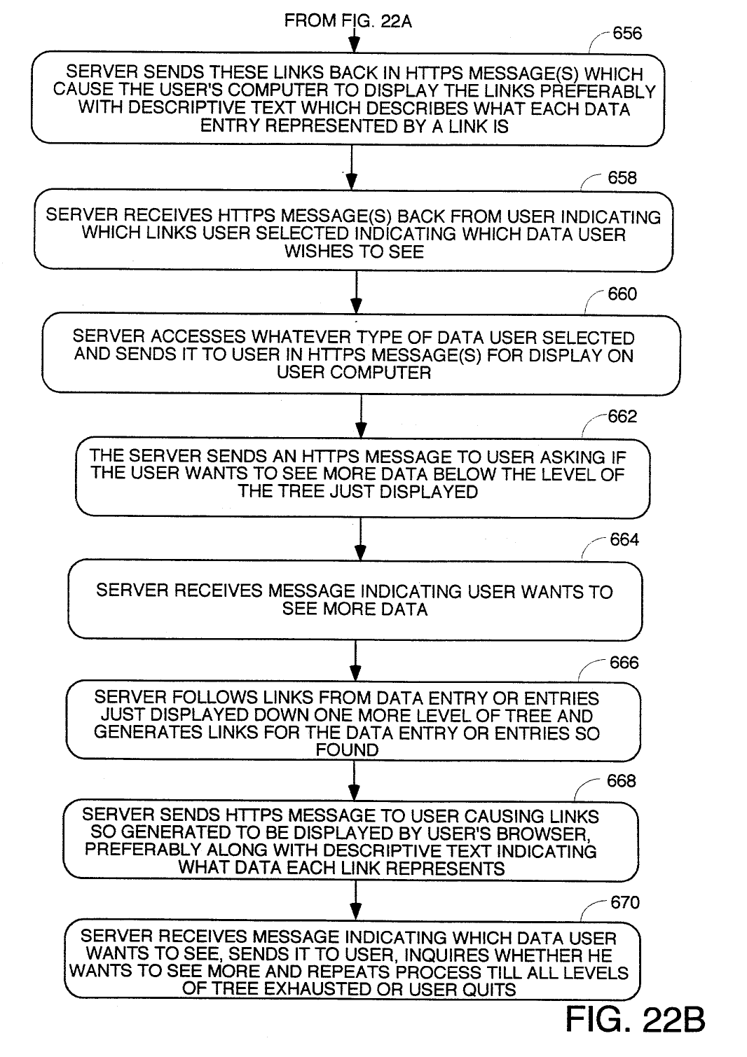

In the preferred embodiment, the data structure is presented to the user one level of the tree at a time as links that the user can follow manually to only the data he wants. This process is illustrated in the flowchart of FIG. 22. Step 640 represents the process of receiving a log in communication over the internet at the usage measuring server which provides the user name and password of the user who wishes to view data in the data structure. In step 642, that user is authenticated by comparing the user name and password to configuration data. In step 644, a message is sent to the user's browser which causes it to display a page with links or commands that can be invoked to tell the server what the user wants to do such as view data of a particular entity such as the user itself or one or more of the users licensee in the case of a distributor. In the preferred embodiment, all messages between the user and the usage measuring server are encrypted or otherwise secure such as by use of the HTTPS internet protocol. In step 646, the server receives a message that the user wants to view usage and/or metric and/or CSU data of one or more desinated entities, or licensing terms of one or more provisioning items or data in one or more authorization nodes, etc.

In optional step 646, configuration data is checked to verify that the user may be allowed to have access to the data he requested. This step is used in most embodiments, but in an application of the invention within a large organization such as the U.S. government where all users are authorized to see any data, this step and step 648 may be eliminated. Step 648 represents the branching based upon the results of the check of the configuration data with step 650 being performed to send a permission denied message if no access is authorized.

If access is authorized, step 652 is performed to locate the data entry representing the entity for which the usage data etc. is to be viewed and to follow pointers to other data entries in the data structure down one level in the tree structure. Each vendor, distributor or client licensee in the data structure has a data entry that represents that business entity. That data entry points to other data entries such as resource lists, provisioning item lists and/or authorization nodes. Those data entries contain pointers to other data entries such as resource authorization nodes. Those entries point to other entries such as usage data buffers. Those entries point to other data entries such as metrics ingots. Those entries point to other entries such as CSU ingots or higher level consolidated metrics ingots. The whole combination of data entries and pointers can be thought of as a tree structure with multiple levels. The idea in this particular embodiment is to only display one level of the tree at a time and allow the user to pick the path through the tree manually to only the data she wants to access. Step 652 just finds the data entries which reside down the first level of the tree from the business entity designated by the user.

Step 654 represents the process of generating links for each data entry down the first level of the tree as located in step 652. Step 656 represents the process of sending these links to the user's browser in one or more messages so as to cause the users browser to display these links, preferably along with descriptive text that describes what each data entry represented by a link is or contains. In step 658, the server receives back one or more messages from the user which indicate which data the user has chosen to access by clicking on one or more links. In step 660, the server accesses whatever data the user has selected from the data entries (license terms, data in authorization nodes, raw usage data, metrics, CSUs, etc.) and sends it back to the user in one or more messages. In step 662, the server sends a message to the user causing his computer to display a page which queries whether the user wants to access more data at further levels down in the tree structure. This step can be combined with the step of sending the data to the user for display.

In step 664, the server receives a message that the user wants to see more data. This step is optional and it and subsequent steps are performed only if the user wants to drill down further in the data structure. In step 666, the server follows pointers from the data entry or entries just displayed to the user down one more level in the tree structure to whatever data entries are there. The server then generates links representing these data entries so found. In step 668, the server sends these links to the user's browser via one or messages so as to cause the user's computer to display the links on its display, preferably along with descriptive text which explains what each data entry represented by a link is and/or contains. In step 670, the server receives one or more messages indicating which data the user has selected for access, sends that data to the user, inquires whether the user wants to see more data at lower levels in the tree, and, if so, repeats the process till all levels of the tree are exhausted or the user stops making requests to see more data.

More on Security Barriers

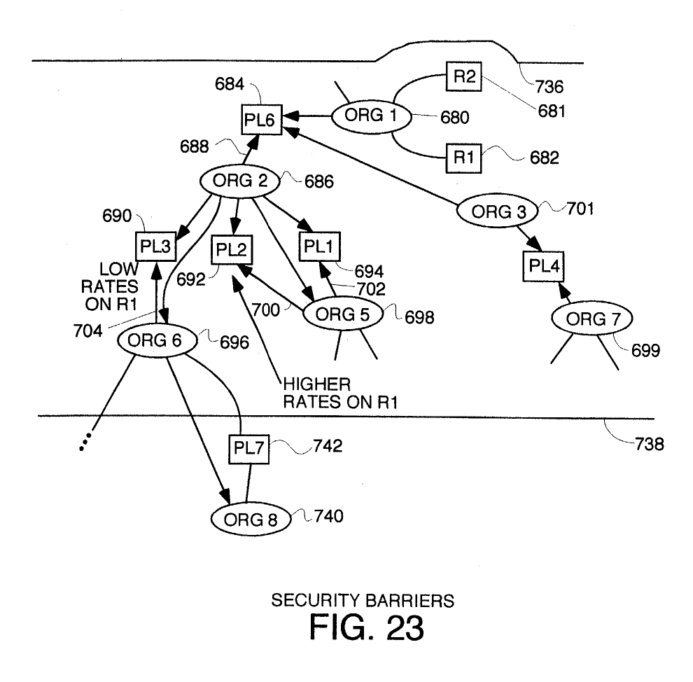

FIG. 23 is a diagram of an example data structure which illustrates some of the concepts of security barriers to prevent users from obtaining access to information in the data structure which does not belong to them. In FIG. 23, a vendor 680 makes a resource 682 and another resource 681 available through the license terms on provisioning list 684. A distributor 686 has a license 688 under the terms of PL6 684 and sublicenses resources 681 and 682 to both big and small users under three different provisioning lists 690, 692 and 694. Resource 682 is licensed at low per use rates to big user 696 under the provisions of provisioning list 690 via link 704. Small user 698 licenses resource 682 at much higher per use rates under the terms of provisioning list 692 via link 700 and licenses resource 681 under the terms of 694 via link 702. There is no link from small user 698 to provisioning list 690 containing the much lower rates for resource 682. None of the organizations 696, 698 and 699 on the same level of the data structure can become aware of the existence of the others by access to the data structure. Each of these organizations can only determine data in the chain of pointers from the vendor of the resource they are licensing through the provisioning item through which they took a license and all the authorization nodes created by that organization or its sublicensees or subdistributors. The security barriers prevent, for example tracing pointers from organization 699 up to provisioning list 684 and back down to organization 696 or 698. Thus, the term “indirectly” as used herein and in the claims to specify data to which an organization is linked by pointers and to which it may have access does not include following pointers up to a common provisioning list used by multiple licensees and then back down to other licensees. The indirect term means only data in the family tree of data items that are direct ancestors by blood or issue of the organization requesting access to the data, so to speak. There are no relatives by marriage such that pointers out of a common ancestor such as provisioning list 684 can be followed down the family tree of another entitty who has a license under the common provisioning list. The security barriers may be implemented in any way to accomplish this restriction such as information in the pointer data or data entries in each family tree which defines what is and what is no not in any particular family tree. The security barriers may also be implemented in such a way that a licensee may not find out about any other organizations above its own licensor so as to prevent licensees from attempting to “cut out the middleman”. The same holds true for security barrier to prevent a distributor from trying to cut out its subdistributors to market directly to the subdistributor's licensees. What this means graphically is that organization 698 can view data below line 736 and above 738 in FIG. 23 but only data entries within its direct family tree. Thus, organization 686 can find out about organization 680 and organizations 696 and 690 but not about organizations 699 or 701 since 699 and 701 are outside its family tree. Likewise, organization 686 will be able to access usage and metrics data of its licensees 696 and 698, but not about any sublicensees of 696 or 698 such as organization 740 which is a licensee of organization 696 through organization 696's provisioning list 742. Organization 696 may be sublicensing resources 682 and 681 in some unique way that would be of interest to organization 686, but it is not able find out about that because of the security barriers. This protects organizations 696 and 698 from being cut out by organization 686. The easiest way to define the limits of this notion of a “family tree” as it is used herein is that when a user logs in, he is limited to obtaining information about only the organizations he directly buys or licenses from or to which he directly sells or licenses. Suppliers or licensors to the organization he buys from are outside his “direct family tree” as are organizations that his customers sell or license to. This is the meaning of the term “direct family tree” as used within the claims.

The system will also work in a so-called “agnostic paradigm” wherein two or more organizations at the same level of a data structure grant access to each other's resources by licensing each other through their provisioning lists. In such a case, the security barriers prevent accessing data outside the “direct family tree” of each organization but allows access to data of any other organization in a horizontal “agnostic paradigm”.

Therefore, in this embodiment where security barriers of the nature just described are implemented and one-stop shopping to view all available licenses on a particular resource is not enabled, if small user 698 logs into the server 20 and attempts to view the terms other licensees are getting on the same resource, he will be blocked from doing so by the lack of a link to provisioning list 690. In alternative embodiments, configuration data can be used to limit the provisioning lists certain users or certain classes of users can view when they log in and request to view all available licenses on a particular resource.

Of course the security barriers are just data, and they can be disabled or modified in several ways. For example, the security barriers can be modified in some embodiments so that any organization can see the usage data and provisioning lists of any other entity below it in the data structure. Alternatively, the security barriers may be removed altogether so as to allow any entity in the data structure to view the data anywhere else in the data structure so as to enable a competitive free for all.

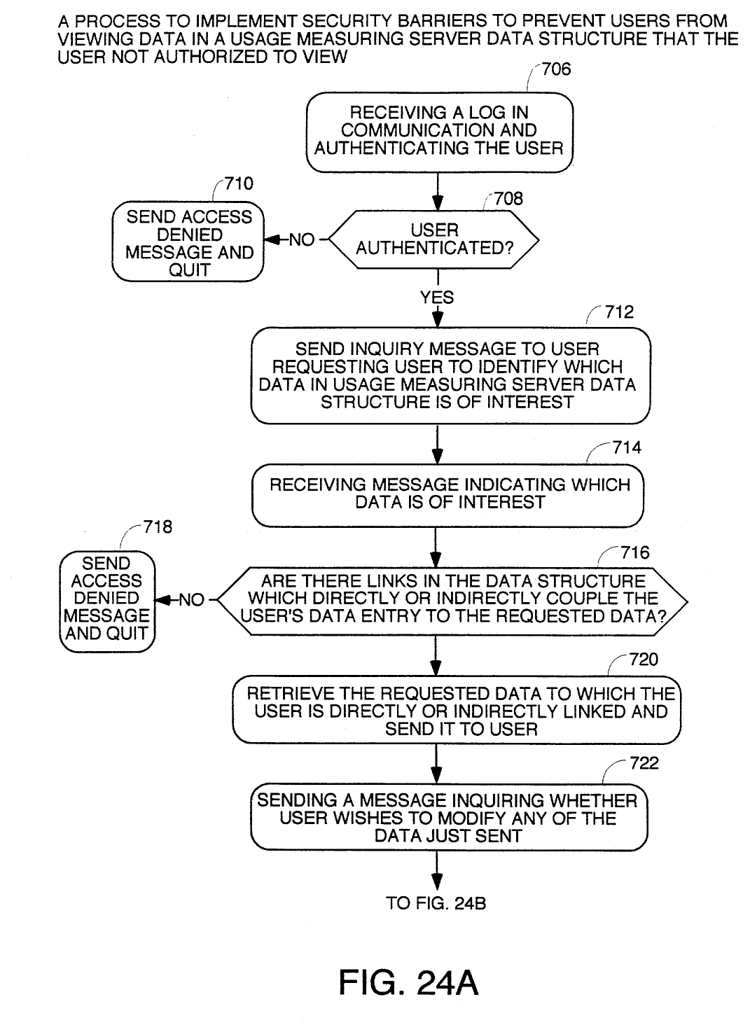

FIGS. 24A and 24B are a flowchart of the process to limit access of a user to only that data in the data structure to which the user's data entry is directly or indirectly linked, and to only allow modification of accessed data by users authorized to modify that type of data. Step 706 receives the log in communication from a user who wishes to view or modify data in the data structure and authenticates the user. If the user is not authenticated, steps 708 and 710 deny access. Step 712 sends a message to the authenticated user asking her which data she would like to view and/or modify. Step 714 represents the process of receiving a message indicating which data is of interest. Step 716 represents the process of locating the data entry which represents the user in the data structure and following links from that data entry to all levels of the tree data structure defined by data entries which are coupled to the user through links such as provisioning lists, resource lists, authorization nodes, resource authorization nodes, usage data buffers, metric ingots, CSU ingots or higher level combined metric ingots. If the requested data is not anywhere in this tree structure, step 718 is performed to deny access to the requested data. If the requested data or some part of it is in the tree structure, then step 720 is performed to retrieve the portion of the requested data which is in the tree structure and send it to the user. That ends the process of accessing data. The steps following step 720 define security barriers to modification of data.

Step 722 is a process of sending a message to the user inquiring whether the user wants to modify any of the data just sent. Steps 724 and 726 quit and wait for the next request if the user does not indicate he wants to modify any of the data. If the user indicates he wants to modify some specified data, step 728 checks configuration data to determine if this particular user is allowed to modify the particular type of data he specified. For example, a licensee is not allowed to modify his own usage data or metrics or CSUs, and a distributor is not allowed to modify usage data, metrics or CSU data of his licensees, but may be allowed to modify the distillation program or CSU distillation programs and is allowed to declare new resources, new licensees, new subdistributors, etc.

If the configuration data indicates that modification of the specified data is not allowed, steps 730 and 732 send a message denying modification privileges to the user. If modification is allowed, step 734 represents sending a modification allowed message, waiting for the user to send back the modified data and then storing it in the data structure.

More on Using the Server Data Structure for Efficient One Stop Shopping

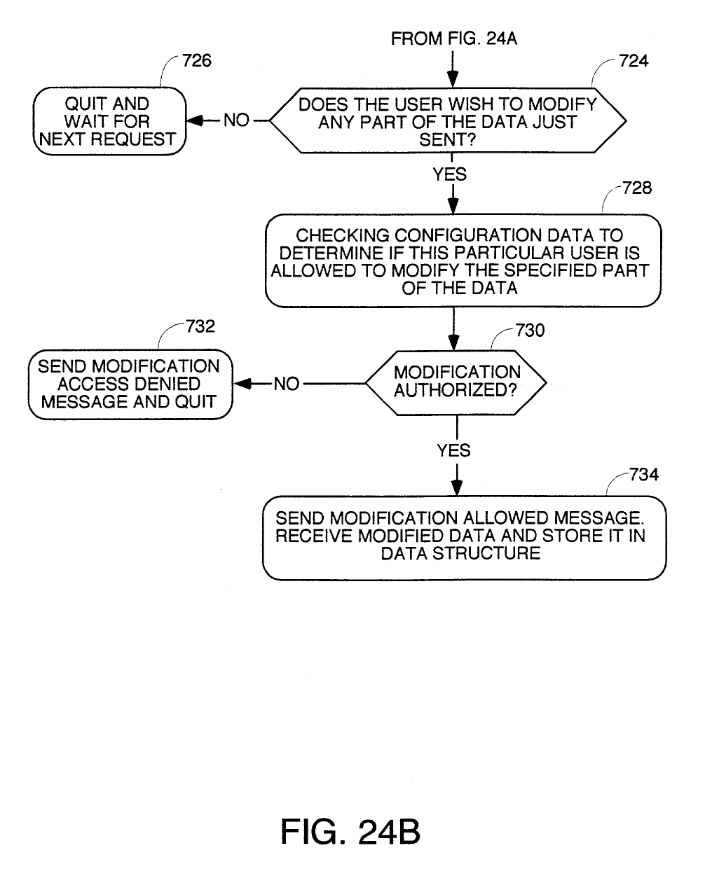

The server 20 may also maintain a data structure which is useful to do one stop shopping to find the best deal or closest vendor of a particular item for sale as opposed to usage-based licensing of resources like software or perhaps just to find a particular rare item on sale anywhere in the country. FIG. 25 is an exemplar data structure for distribution of resource items R1 through R12 for sale by two vendors 750 and 752 through a nationwide network of regional distributors 754, 756, 758, 760 and 762, each of which sells the resources directly and through retail stores in their area such as stores 764, 766, 776 and 752 and subdistributors 768 and 770 who supply their own retail stores such as 772. The provisioning lists and provisioning items are not shown for clarity, and there are no usage data buffers but there may be sales volume buffers that each seller records his sales volume and other information which may be of interest such as velocity of movement off the shelves, inventory of each item, etc.. As was the case for usage-based licensing data structures, these data items may be accessed by vendors, distributors, subdistributors suppliers etc. using any of the access protocols and security paradigms described above for the usage-based licensing data structures.

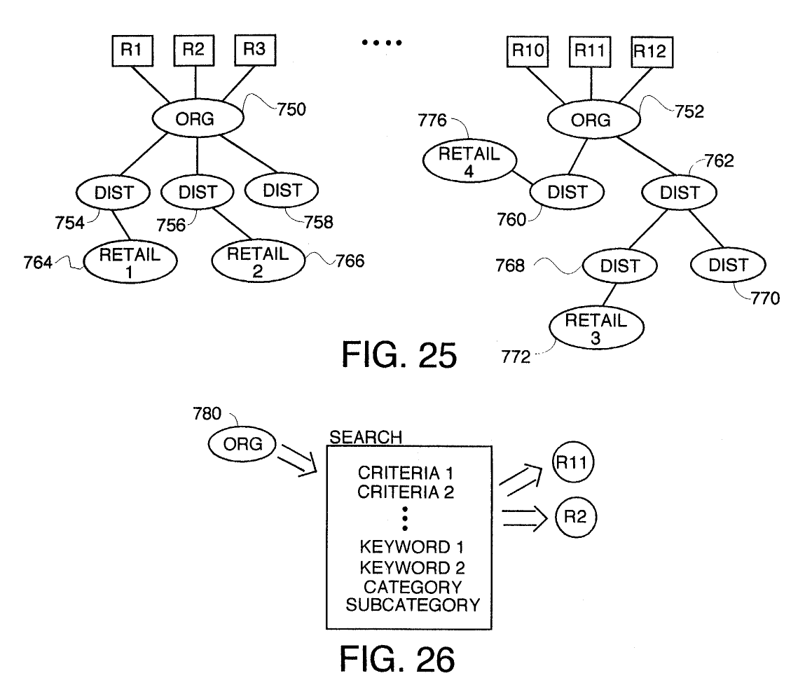

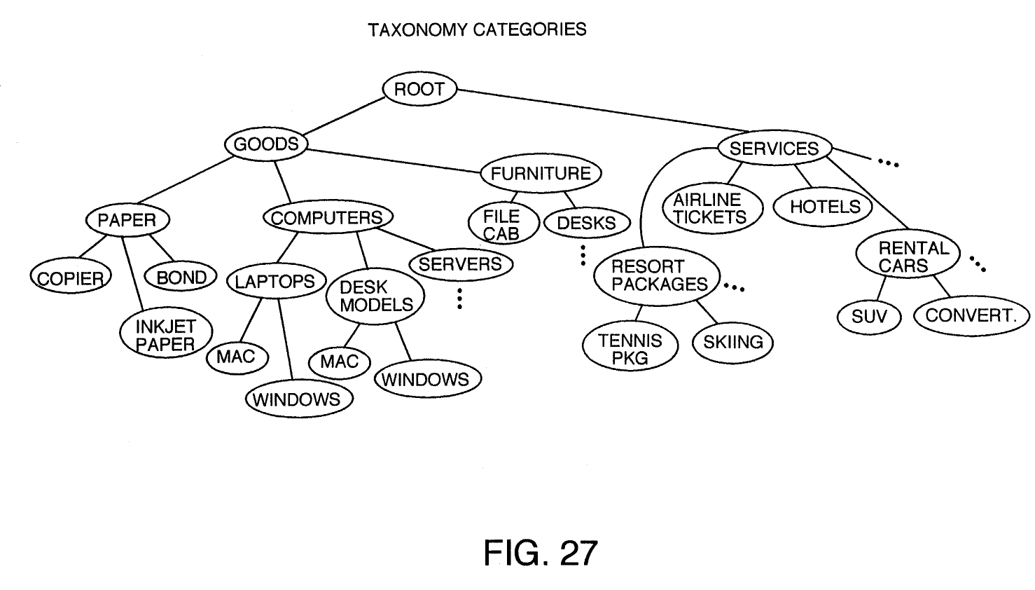

FIG. 26 represents a diagram of a search template, organization 780 with an interest in obtaining some resource may compose to search the data structure of FIG. 25. A similar type search template may be composed to search any of the usage based licensing data structures also. In this search template, organization 780 defines several criterion that the resource it is looking for will have, and it may define one or more keywords that will be in the data entry describing the resource being sought. The search template may also contain a category and several subcategories from a taxonomy of categories within which resources represented by data entries in the data structure fall. FIG. 27 shows a typical taxonomy.

Suppose organization 780 is looking for a Mac OS laptop under four pounds with a battery life of greater than 4 hours and with a built in DVD drive that can read CDs also. In such a case, the search template categories can be set to: goods, computers, laptops, MAC OS and the criteria fields can be set to less than four pounds and greater than 4 hours battery line and keywords can be DVD and CD.

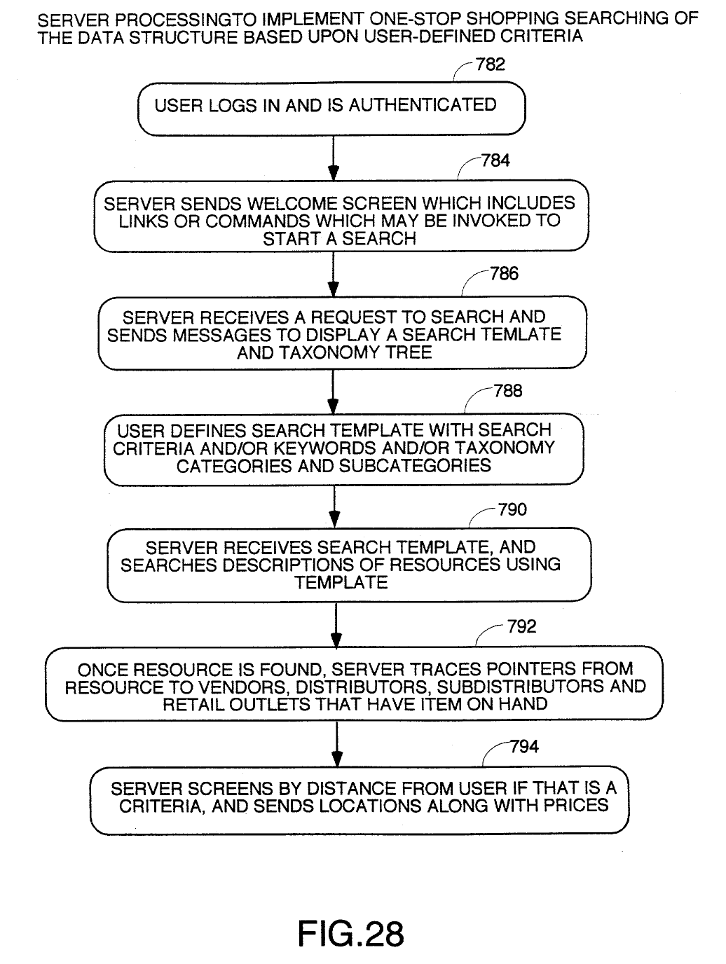

FIG. 28 is a flowchart of typical processing to allow searching of the data structure based upon user defined criteria. The user can compose this template offline or online using his browser after he logs in. For this example, assume the user composes the search template on-line because of lack of information of the taxonomy categories available. After log in and authentication, represented by step 782, the server sends messages to the user's browser which cause it to display a welcome screen in step 784. The welcome page has a search link or command that the user can invoke to request a search. This will trigger the server in step 786 to send messages which will cause the user's browser to display a blank search template and a display of the taxonomy of categories within which the goods in the data structure fall. In step 788, the user fills in the search template with search criteria, and/or keywords and/or categories and subcategories from the taxonomy and sends it back to the server. In step 790, the server receives the search template and uses its data to screen the data descriptions of each available resource. Assuming one or more resources are found which satisfy the criteria, in step 792 the server then traces pointers in the data structure to all the vendors, distributors, subdistributors and/or retail stores from which the resource may be purchased using inventory on hand data stored in the data structure and coupled to each such outlet. In step 794, the server screens the available outlets where the item may be purchased by distance from the company looking from the item if that company has specified a maximum distance it is willing to travel. Then, the remaining candidates outlets from which the item may be purchased, or all of them if no further screening criteria were specified, are sent in step 794 to the user along with their address, phone number and their published price for the item, the number on hand any current or future promotions on the item, etc.. Some of this data such as the price, number on hand, special promotions on the item, etc. may be omitted.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A process for collecting usage data and generating metrics that measure use in a usage based resource licensing system to measure usage of one or more resources by distributed clients, comprising:
1) using a monitoring or agent program installed on one or more distributed computers of licensees to collect usage data for usage of one or more resources installed on said one or more computers;
2) transmitting said usage data to a usage measuring server from time to time;
3) receiving and storing in a data structure in said usage measuring server said usage data collected by all said monitoring or agent programs to create buffers of raw usage data that store all usage data of all resources by all licensees, each said buffer of raw usage data containing data recording use of one resource by one licensee;
4) for each buffer of raw usage data of one resource by one user, using the appropriate distillation program to convert the raw usage data into metric data and storing said metric data in said data structure; and
5) allowing authorized persons access to at least said metric data, and preparing reports or invoices based upon use reflected in said metric data.

2. The process of claim 1 further comprising a step wherein authorized persons may access said metric data over the internet through use of a browser on the authorized person's computer which interacts with a web interface implemented by said usage measuring server or via any other wide area network or by direct dial up access.

3. The process of claim 2 wherein said usage measuring server implements steps to control access by said authorized persons so that said authorized persons are only allowed access to predetermined metric data and/or raw usage data such that said authorized persons cannot have access to confidential business information of other users, vendors or distributors who have usage data stored in said data structure.

4. The process of claim 3 wherein said usage measuring server is programmed to require a user name and password to log in for access to metric and/or usage data, and wherein said usage measuring server is programmed to use said user name and password to authenticate the identity of a user who has logged in and use said identity to consult configuration data that controls which metrics and/or raw usage data or metrics alone or metrics in combination with CSU units or CSU units alone to which said user may have access.

5. The process of claim 1 wherein said usage measuring server directly or indirectly sends data to said agent programs from time to time to control what types of usage data are collected and indicating which resources still are authorized for use such that continued use of a resource whose license has expired or for which a licensee has not honored the terms of its license may be blocked.

6. The process of claim 1 wherein said usage data is stored in a manner or with accompanying data which indicates the time when said usage occurred, and wherein said usage data is stored in separate logical time compartments, each representing usage over one time interval in a sequence of said time intervals.

7. The process of claim 6 where the duration of one said time compartment is programmable.

8. The process of claim 6 wherein the duration of a said time compartment is programmable.

9. The process of claim 7 wherein the duration of said sequence of said time compartment is programmable.

10. The process of claim 6 wherein step 4 comprises using said distillation program to process the usage of each time compartment or logical compartment to generate metrics for each said time compartment.

11. The process of claim 6 wherein step 4 comprises using said distillation program on a fixed schedule to process the usage data in each time compartment.

12. The process of claim 6 wherein step 4 comprises processing each time compartment of usage data by following pointer data to the appropriate distillation program for the resource to which the usage data pertains and using that distillation program to process the usage data in the time compartment, and repeating this step for every time compartment of every usage data buffer.

13. The process of claim 6 further comprising the step of executing a CSU distillation or mapping program at least once during every larger interval of which each said time compartment is a part and processing the metrics calculated for each time compartment into CSU units.

14. The process of claim 6 wherein step 4 comprises processing usage data from a time compartment using the appropriate distillation program multiple times during the interval represented by said time compartment.

15. The process of claim 14 wherein each time said distillation program is run during the interval represented by said time compartment, all the usage data stored in said time compartment that has been stored before the time of execution of said distillation program is input to said distillation program such that the metrics for said time compartment are restated to include all the new usage data stored since the last execution of said distillation program.

16. A process for collecting usage data and generating metrics that measure use in a usage-based based resource licensing system to measure usage of one or more resources by distributed clients, comprising steps for:
1) using a monitoring or agent program installed on one or more distributed computers of licensees to collect usage data for usage of one or more resources installed on said one or more computers;
2) transmitting said usage data to a usage measuring server from time to time;
3) receiving and storing in a data structure in said usage measuring server said usage data collected by all said monitoring or agent programs to create buffers of raw usage data that store all usage data of all resources by all licensees, each said buffer of raw usage data containing data recording use of one resource by one licensee, said usage data being segregated into logical or physical time compartments, each storing the usage data for usage during one time interval in a larger interval comprised of a sequence of contiguous ones of said time intervals;
4) for each buffer of raw usage data of one resource by one user, using the appropriate distillation program to convert the raw usage data into metric data for each said time compartment of each said usage buffer and storing said metric data in said data structure; and
5) if requested or scheduled, summarizing the metrics generated for each time interval during said larger interval.

17. The process of claim 16 wherein the length of said larger interval is programmable and determined by reading configuration data.

18. The process of claim 16 wherein the number of times said distillation program is run during a time interval represented by a time compartment to convert usage data from said time compartment into metrics is programmable and the method by which said distillation program distills said usage data with regard to whether the distillation program processes only new data or both new and old data is programmable.
